(19) United States
(12) Patent Application Publication
(10) Pub. No.: US 2002/0046407 A1
(43) Pub. Date: Apr. 18, 2002

(54) Use of web pages to remotely program a broadcast content recording system

(76) Inventor: Alexander Franco, Corona Del Mar, CA (US)

Correspondence Address: Alexander Franco, 417 Marguerite Ave, Corona Del Mar, CA, 92625-2334, US

(21) Appl. No.: 09/789,445

(22) Filed: Feb. 20, 2001

Related U.S. Application Data
(60) Provisional application No. 60/183,761, filed on Feb. 18, 2000.
(60) Provisional application No. 60/184,308, filed on Feb. 22, 2000.

(51) Int. Cl. H04N 7/173

(52) U.S. Cl. 725/110

(57) ABSTRACT

A remotely programmable broadcast content recording system is programmed through a web page to record broadcast content such as television programs. Accordingly, a user can select content of interest and program the system from almost any location using a web browser. A host system hosts a web site through which the user can browse program listings and select content. In response to the selection of a program by the user, the host system creates programming data and transmits the programming data to the user's recording system. The recording system can be configured to receive transmissions from the host system. A client programming module configured to receive the transmissions can be used to program a conventional recording device. The recording system can be supplemented with a web server and an Internet connection to provide a point of presence on the World Wide Web through which the system can be directly programmed.

### PRIORITY INFORMATION

This application claims the benefit of U.S. Provisional Application No. 60/183,761, filed on Feb. 18, 2000 and U.S. Provisional Application No. 60/184,308, filed on Feb. 22, 2000.

### BACKGROUND OF THE INVENTION

1. Field of the Invention

This invention relates generally to the recording of broadcast content, such as television content, and, more particularly, the invention relates to a system that supports the remote programming of a content recording device through web pages.

2. Description of the Related Art

Video recording devices are widely used to record and replay broadcast video content (e.g., transmitted open-air, cable, and satellite television). Video recording devices include videocassette recorders (VCR) and digital video recorders, otherwise known as personal video recorders, which are typically programmable to automatically record specified channels at specified times. These recording devices are typically programmed using a hand-held remote control and through on-screen menus output to a television set. The menus typically allow a user to select a channel and a time period during which the recording device will automatically record a program.

Some video recording devices are enabled with VCR-Plus technology (known as Video Plus in Europe). VCR-Plus codes are created by an algorithm that transforms a channel and time period into a numeric code. A user can read a VCR-Plus code from a published program grid and supply the code to the video recording device, preferably through a hand-held remote control. Based upon the VCR-Plus code, the device determines the appropriate time and channel to record and records the program (also referred to herein as “content unit”) identified by the code. VCR-Plus technology is available from Gemstar International Group Limited.

Some video recording devices are configured to download broadcast program schedules each night via a phone connection. The video recording device uses the downloaded schedules to display program guides or grids, generally through on-screen menus. A user selects programs to be recorded from the guide or grid, preferably using a remote control. TiVo Inc. of Sunnyvale, Calif. and ReplayTV, Inc. of Mountain View, Calif., as well as EchoStar Communications of Littleton, Colo. in conjunction with WebTV of Mountain View, Calif. provide digital video recording devices with these features.

Available broadcast content recording systems generally require a user to program a recording device using a remote control through on-screen menus. The remote control and on-screen menu system has several deficiencies. A remote control typically has a limited number of input keys and therefore, entry of words is difficult (e.g., to search for a particular title in a program grid). Oftentimes, the on-screen menus are difficult to understand and difficult to navigate. In the case that program guides or grids are displayed, the television screen upon which the menus are displayed oftentimes does not have the resolution to display a substantial amount of the guide. Accordingly, the user is required to flip from screen to screen to find programs of interest. Furthermore, the user needs to be in the presence of the recording device in order to use the combination of remote control and on-screen menus. Accordingly, it is not possible to program these types of content recording systems from remote locations, such as from work or while traveling.

U.S. Pat. No. 5,016,273 to Hoff discloses a system that enables a user to remotely program a VCR by placing a telephone call to an interactive voice response system and entering a channel, a time period, and an identifier that identifies a recording device. The system then sends a signal to the identified recording device causing the device to record the selected channel and time period.

International Application WO 96/13932 to Ng discloses another system in which a user places a call to a representative and supplies a recorder identifier and an identification of a program to be recorded. The representative encodes the identification in channel, date, time, and length (CDTL) format in conjunction with the recorder identifier and transmits the CDTL data and identifier in a vertical blanking interval of a broadcast signal. The user's recorder receives the CDTL data and identifier through the broadcast signal, and upon recognizing a matching identifier, stores the CDTL data to enable subsequent automatic recording of the identified program.

Although Hoff and Ng do disclose systems that enable the remote programming of a VCR, they do not present the user a selection of available broadcast from which to choose. Furthermore, these systems require a telephone call to be placed, which is a very inconvenient manner in which to program a VCR.

The present invention seeks to address the aforementioned deficiencies in the prior technology in addition to providing previously unavailable advantages and conveniences.

### SUMMARY OF THE INVENTION

A remotely programmable broadcast content recording system is programmed through a web page to record broadcast content such as television programs. Accordingly, a user can select content of interest and program the system from almost any location using a web browser. A host system hosts a web site through which the user can browse program listings and select content of interest. In response to the selection of a program by the user, the host system creates programming data and transmits the programming data to the user's recording system. The recording system can be configured to receive transmissions from the host system. A client programming module configured to receive the transmissions can be used to program a conventional recording device. The recording system can be supplemented with a web server and an Internet connection to provide a point of presence on the World Wide Web through which the system can be directly programmed.

One embodiment of the invention is a method of programming a remotely programmable content recording system to record broadcast content. The method includes (a) receiving a programming instruction transmitted over a computer network by a user computer in response to a user's input to the user computer. The programming instruction identifies broadcast content that has been selected by the user to be recorded by the remotely programmable content recording system. The method also includes (b) using the received programming instruction to program the remotely programmable content recording system to record the identified content.

The following aspects can, but need not be included in the aforementioned embodiment. The user's input can be received through a web browser executing on the user computer. The user's input to the user computer can include a selection of a user-selectable display element. The method can also include transmitting a web page to the user computer, wherein the web page is configured to cause the web browser to display the user-selectable display element. The method can also include transmitting a programming web page to the user computer in response to a request transmitted by the user computer, wherein the programming web page includes code configured to cause the web browser to display to the user an identification of the broadcast content. The programming web page can also include code that configures the web browser to receive the input from the user. The method can also include serving a state web page in response to a request transmitted by the user computer, wherein the state web page includes code configured to cause the web browser to display state information descriptive of a state of the remotely programmable content recording system. The state information can include an amount of storage capacity available on the recording system for recording new content. In the method, (b) can be performed by the remotely programmable content recording system. The computer network can be the Internet. The programming instruction can identify a broadcast television program. The programming instruction can identify a time period and a broadcast channel. The programming instruction can include a VIDEO PLUS code. The broadcast content can be broadcast television content. The broadcast content can be audio content. The broadcast content can be digital video content. The broadcast content can be computer software. The remotely programmable content recording system can include a programmable content recording device and a separate programming device configured to receive programming data, wherein the programming device is connected in at least one-way communication with the programmable content recording device. In the method, (b) can include, in response to receiving the programming instruction, transmitting programming data to the remotely programmable content recording system, wherein the programming data are configured to cause the remotely programmable content recording system to record the selected content. The programming data can identify the broadcast content. The programming data can include the programming instruction. The broadcast content can be broadcast in encrypted form. The method can also include, in response to receiving the programming instruction, transmitting a content decryption key to the remotely programmable content recording system, wherein the content decryption key can be used to decrypt the broadcast content. The content decryption key can be encrypted in such a manner that the content decryption key can be decrypted by the remotely programmable content recording system. The content decryption key can be encrypted in such a manner that the content decryption key cannot be decrypted by other remotely programmable content recording systems.

One embodiment of the invention is a method of programming a remotely programmable content recording system to record broadcast content. The method is preferably performed by a user computer. The method includes (a) receiving input from a user, wherein the input includes an identification of a content unit. The method also includes (b) in response to (a), transmitting over a computer network to a server, a programming instruction configured to cause the remotely programmable content recording system to be programmed to record the identified content unit.

The following aspects can, but need not be included in the aforementioned embodiment. The method can also include transmitting to the server an identifier that is used to uniquely identify the remotely programmable content recording system. The user input can be received through a web browser executing on the user computer. The user's input to the user computer can include a selection of a user-selectable display element. The method can also include receiving a web page, wherein the web page is configured to cause the web browser to display the user-selectable display element. The method can also include receiving a programming web page in response to a request, wherein the programming web page includes code configured to cause the web browser to display to the user an identification of the content unit. The programming web page can also include code that configures the web browser to receive the input from the user. The remotely programmable content recording system can include the server. The programming instruction can include a request that the content unit be broadcast, wherein the content unit is broadcast based at least in part upon the transmission of the programming instruction. The computer network is the Internet.

One embodiment of the invention is a host system for remotely programming a remotely programmable content recording system. The host system includes a server configured to receive a programming instruction transmitted over a computer network by a user computer, wherein the programming instruction is transmitted in response to a user's input to the user computer, and wherein the programming instruction identifies broadcast content that has been selected by the user to be recorded by the remotely programmable content recording system. The host system also includes a control module configured to create programming data based at least upon the programming instruction, wherein the programming data are configured to cause the remotely programmable content recording system to record the identified broadcast content. The host system also includes a communication module configured to transmit the programming data to the remotely programmable content recording system.

The following aspects can, but need not be included in the aforementioned embodiment. The server can be a web server and the user's input can be received through a web browser executing on the user computer. The web server can be configured to serve a programming web page to the web browser in response to a request transmitted by the web browser, wherein the programming web page includes code configured to cause the web browser to display to the user an identification of the broadcast content. The programming web page can also include code that configures the web browser to receive the input from the user. The host system can also include a computer system comprising a processor and an operating system, wherein the server, the control module, and the communication module are configured to operate under the control of the computer system. The computer network can be the Internet. The broadcast content can be broadcast in encrypted form. The control module can be further configured to transmit a content decryption key to the remotely programmable content recording system, wherein the content decryption key can be used to decrypt the broadcast content. The control module can also be configured to encrypt the content decryption key to enable secure communication of the key to the remotely programmable content recording system. The server and the control module can be integrated.

One embodiment of the invention is a remotely programmable broadcast content recording system. The system includes a programmable broadcast content recording module. The system also includes a server configured to receive a programming instruction transmitted over a computer network by a user computer, wherein the programming instruction is transmitted in response to a user's input to the user computer, and wherein the programming instruction identifies broadcast content that has been selected by the user to be recorded by the programmable content recording module. The system also includes a communication module configured to enable access to the server to be initiated from a computer network.

The following aspects can, but need not be included in the aforementioned embodiment. The server can be a web server and the user's input can be received through a web browser executing on the user computer. The web server can be configured to serve a programming web page to the web browser in response to a request transmitted by the web browser, wherein the programming web page includes code configured to cause the web browser to display to the user an identification of the broadcast content. The programming web page can also include code that configures the web browser to receive the input from the user. The server can also be configured to provide programming data to the recording module, wherein programming data are based at least upon the programming instruction, and wherein the programming data identify the broadcast content. The recording system can also include a tuner configured to receive and decode a broadcast signal. The recording system can also include a computer system including a processor and an operating system, wherein the programmable broadcast content recording module, the server, and the communication module are configured to operate under the control of the computer system. The computer network can be the Internet. The programmable broadcast content recording module can include a digital video codec and a hard disk drive. The recording system can also include a digital broadcast signal receiver.

One embodiment of the invention is a hypertext link configured such that a traversal of the link causes a programming instruction to be transmitted over a computer network, wherein the programming instruction identifies a broadcast content unit, and wherein the programming instruction is configured to cause the identified broadcast content unit to be recorded by a remotely programmable broadcast content recording system.

One embodiment of the invention is a web page. The web page includes an identification of a content unit scheduled to be broadcast. The web page also includes code that configures a web browser to transmit a programming instruction in response to input from a user, wherein the programming instruction is configured to cause a remotely programmable content recording system to record a broadcast of the content unit.

The following aspects can, but need not be included in the aforementioned embodiment. The content unit can be identified in a clickable broadcast program grid. The clickable broadcast program grid can depict broadcast programs based upon at least broadcast time and broadcast channel.

One embodiment of the invention is a method of providing broadcast content. The method includes (a) receiving from a user an identification of a content unit. The method also includes (b) causing the content unit to be broadcast based at least in part upon the receipt of the identification. The method also includes (c) transmitting programming data to a remotely programmable content recording system associated with the user, wherein the programming data are configured to cause the remotely programmable content recording system to be programmed to record the broadcast content unit.

The following aspects can, but need not be included in the aforementioned embodiment. In the method, (a) can include receiving a request transmitted over a computer network by a user computer in response to user input to the user computer, wherein the request identifies the content unit. The content unit can be broadcast in encrypted form. The method can also include transmitting a content decryption key to the remotely programmable content recording system, wherein content decryption key can be used to decrypt the broadcast content unit. The content decryption key can be encrypted in such a manner that the content decrypton key can be decrypted by the remotely programmable content recording system.

One embodiment of the invention is a method of programming a remotely programmable content recording system to record broadcast content. The method includes (a) associating a user with the remotely programmable content recording system. The method also includes (b) authenticating the user through a web browser executing on a user computer. The method also includes (c) in response to at least (b), placing a web browser cookie on the user computer. The method also includes (d) receiving the cookie in conjunction with a programming instruction, wherein the programming instruction identifies broadcast content that has been selected by the user to be recorded by the remotely programmable content recording system. The method also includes (e) in response to at least (d), causing the remotely programmable content recording system to record the identified content.

The following aspects can, but need not be included in the aforementioned embodiment. The cookie and the programming instruction can be transmitted by the user computer in response to a selection by the user of a hypertext link displayed on a web page. The hypertext link can be associated with a banner advertisement.

One embodiment of the invention is a method of programming a remotely programmable content recording system to record broadcast content. The method includes (a) associating a user with the remotely programmable content recording system. The method also includes (b) authenticating the user through a web browser executing on a user computer. The method also includes (c) in response to at least (b), placing a web browser cookie on the user computer. The method also includes (d) receiving the cookie in conjunction with a request from the web browser. The method also includes (e) in response to at least (d), identifying a content unit that is scheduled to be broadcast and receivable by the remotely programmable content recording system and transmitting data to the web browser to thereby cause the web browser to provide an identification of the content to the user. The method also includes (f) receiving a programming instruction transmitted by the web browser in response to an action by the user. The method also includes (g) in response to at least (f), causing the remotely programmable content recording system to record the broadcast of the identified content unit.

The following aspects can, but need not be included in the aforementioned embodiment. The request can be a request for an image file, wherein the data include the image file. The request can be a request for a web page, wherein the data include the web page. The programming instruction can identify the content unit.

These and other embodiments of the invention are described in additional detail below in the Detailed Description of the Embodiments, which contains the following Sections:

I. Overview and System Components

II. Host System

III. Remotely Programmable Video Recording System

IV. Communication Link

V. Distribution of Proprietary Content

VI. Program-Identifying Links and Banner Advertisements

VII. Program Request Integration

VIII. Broadcast Scheduling

IX. Recording Other Types of Content

X. Web Server Enabled Video Recording System

XI. Alternative and Additional Embodiments

XII. Conclusion

### BRIEF DESCRIPTION OF THE DRAWINGS

FIG. 1 illustrates one embodiment of the present invention including a remotely programmable video recording system that is remotely programmed by a user through a host system.

FIGS. 2A-C illustrate three example web pages from one embodiment of a web site through which the recording system can be programmed.

FIG. 3 illustrates a functional block diagram of one embodiment of the host system including a control module, a host communication module, and a web server.

FIG. 4A illustrates a process that is preferably performed by the host system to remotely program a video recording system.

FIG. 4B illustrates a preferred process performed by the user and the web browser to remotely program the video recording system.

FIG. 5 illustrates one embodiment of the remotely programmable video recording system in the form of a remotely programmable video recording device.

FIG. 6 illustrates a process that is preferably performed by the remotely programmable video recording device of FIG. 5.

FIG. 7 illustrates an alternative embodiment of the remotely programmable video recording system in the form of a client programming device that programs a conventional video recording and replay device.

FIG. 8 illustrates a process that is preferably performed by the client programming device of FIG. 7.

FIGS. 9A-E illustrate five embodiments of a communication link through which the host communication module and the client communication module communicate.

FIG. 10 illustrates one embodiment of a system for distributing proprietary or paid content.

FIG. 11 illustrates a method for distributing proprietary content.

FIG. 12 illustrates a system in accordance with which a program-identifying hypertext link can be located anywhere on the World Wide Web.

FIG. 13 illustrates a system in accordance with which users can request that certain content be broadcast through a scheduling system.

FIG. 14 illustrates one embodiment of the invention in which a content recording device is supplemented with a web server to provide a point of presence on the World Wide Web.

### DETAILED DESCRIPTION OF THE EMBODIMENTS

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices, components, and methods to those described herein. In other instances, well-known devices, components, and methods have not been described in detail so as not to unnecessarily obscure aspects of the present invention.

Although a number of embodiments of the invention are described below with particular reference to video content, it will be understood by one skilled in the art that the invention can be applied to any type of broadcast content such as, for example, video (with or without audio), audio, data, or software, including digital or analog forms thereof.

As used herein, a content unit can be any item of broadcast content or portion thereof. A content unit can include one or more segments or portions of broadcast content. A content unit may include any duration of broadcast content regardless of the relatedness of the content broadcast during the duration. For example, a content unit can be a half hour program to be broadcast this evening on television channel 4 wherein any commercial breaks can, but need not be included in the content unit.

### I. Overview and System Components

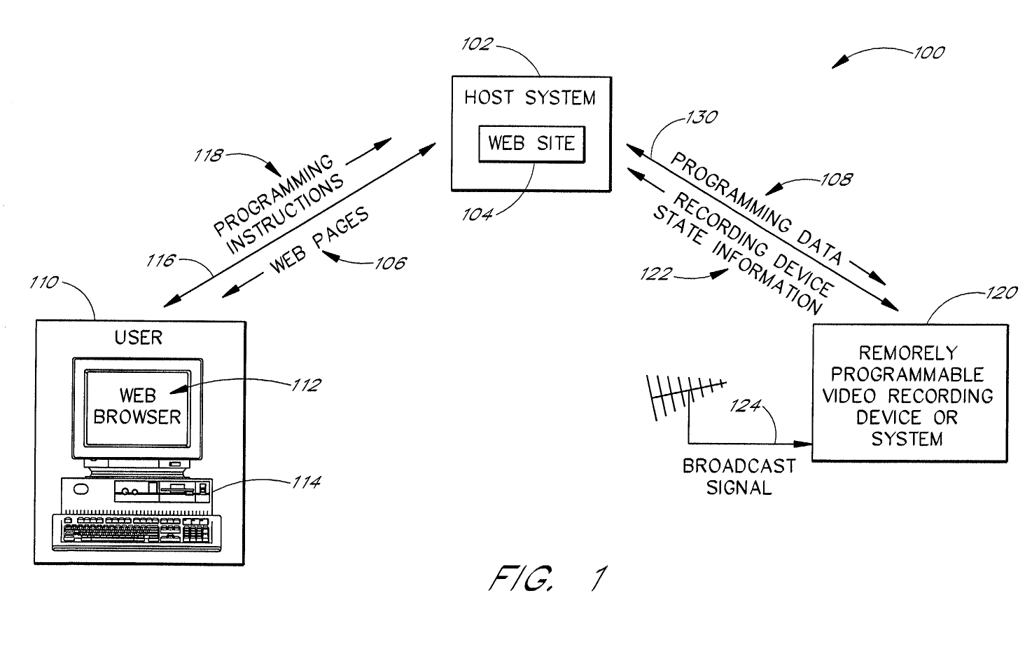

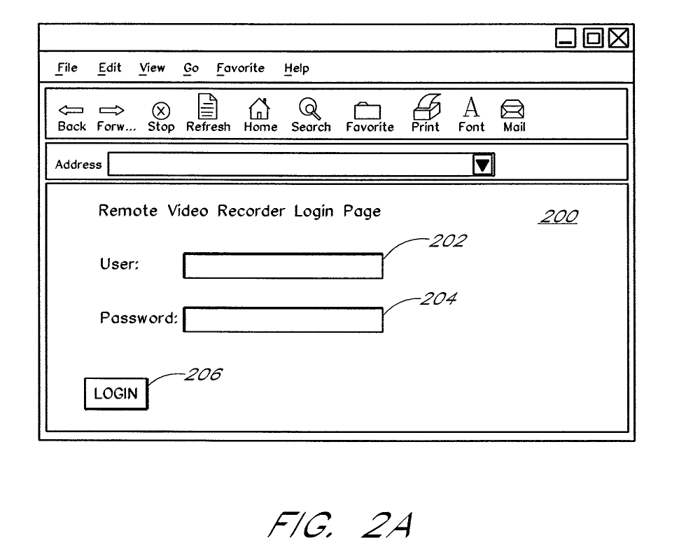

FIG. 1 illustrates one embodiment 100 of the present invention. A host system 102 hosts a web site 104 through which a user 110 programs a remotely programmable video recording system 120 to record broadcast video content. The host system 102 is preferably operated by an organization (not illustrated) that provides a recording system programming service. The host system 102 can alternatively be set up or owned by the user 110 and can be located in the user's home in conjunction with a remotely programmable video recording system 120.

The user 110 accesses the web site 104 through a web browser 112 running on a user computer 114 capable of accessing and displaying web pages. The user computer 114 may be, for example, a personal computer, a palmtop device configured with a web browser, a wireless device that may access web pages using wireless applications protocol (WAP), or a web-browser enabled set-top box. In one embodiment, the user computer 114 is also the remotely programmable video recording system 120. The user computer 114 is preferably connected to the host system 102 through a computer network 116, such as the Internet. The computer network 116 can include a combination of networks, such as a wireless network combined with the Internet. The computer network 116 preferably supports TCP/IP.

The host system 102 provides (serves) web pages 106 of the web site 104 to the user 110 through the computer network 116, the user computer 114, and the web browser 112. The user 110 provides programming instructions 118 to the host system 102 through the web browser 112, the user computer 114, and the computer network 116. The programming instructions 118 preferably identify one or more programs or content units that the user 110 has chosen to record. A program or content unit can be identified in any number of ways, such as, for example, by a name, by an identifier (e.g, Video Plus code or other identifier associated with a particular content unit), or by a broadcast channel, date, time, and length (CDTL). CDTL data can be obtained from widely available electronic programming guides (EPG). The content unit can be identified generically, such as to identify a repeating program by the same title, or the content unit can be identified specifically, such as to identify a particular episode of a repeating program.

The host system 102 creates programming data 108 based upon the programming instructions 118 supplied by the user 110. The programming data 108 includes information sufficient to program the video recording system 120 to record broadcast content in accordance with the programming instructions 118 supplied by the user 110. The host system 102 transmits the programming data 108 to the video recording system 120 over a communication link 130. Any communication link 130 capable of supporting communication from the host system 102 to the video recording system 120 can be used. The communication link 130 can be, for example, a telephone system, a computer network, an open-air broadcast television system, a cable television system, a satellite television system, a pager system, or any combination thereof. Various embodiments of the communication link 130 are described in Section IV below.

The communication link 130 preferably also supports transmission of data from the video recording system 120 back to the host system 102. In this configuration, the video recording system 120 can send state information 122 back to the host system 120 for presentation to the user 110 through the web site 104. The state information 122 can include, for example, the used and available recording capacity of the video recording system 120.

The video recording system 120 preferably includes a digital video recording device or an analog video recording device, in addition to a communication module. The video recording system 120 is described in further detail in Section III below. The video recording system 120 receives a broadcast signal 124, preferably through a television antenna, cable television, or satellite television. The video recording system 120 records video content from the broadcast signal 124 in accordance with the programming data 108 received from the host system 102. The video recording system 120 preferably also has playback capability that allows recorded content to be presented on a television or other display device.

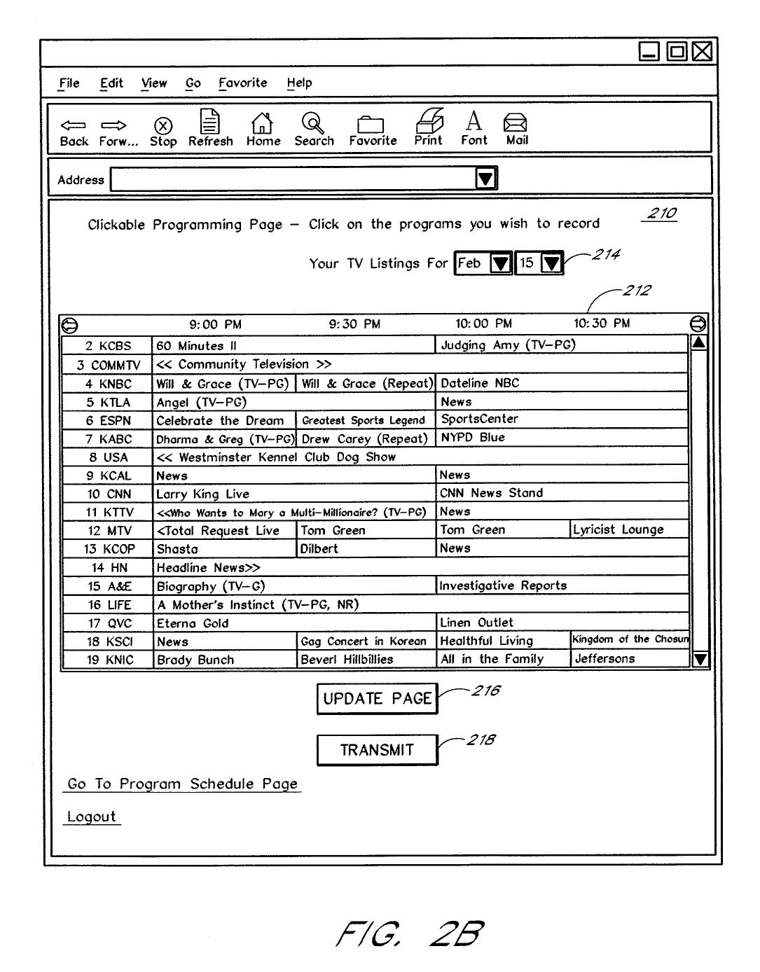

FIGS. 2A-C illustrate three example web pages from a one embodiment of the web site 104. FIG. 2A illustrates a Login Page 200, which prompts a user for identification information 202, such as a user ID, and authentication information 204, such as a password. In an alternative embodiment, the function of the Login Page 200 can be achieved by depositing an identifying web browser cookie on the user's web browser 112 and later receiving the identifying cookie.

Upon entering the identification information 202 and authentication information 204, the user clicks on a Login button 206, which, upon a successful login, preferably brings the web browser 112 to a Clickable Programming Page 210, as illustrated in FIG. 2B. The Programming Page 210 preferably displays a program grid 212. The program grid 212 preferably lists broadcast programs that are receivable by the user's video recording system 120. Channels are preferably listed along a left column, times are preferably listed along a top row, and program blocks are preferably listed across rows in the body of the grid 212. The time periods displayed by the grid 212 are preferably changed by clicking on arrows in the upper left and upper right hand comers of the grid 212. The date of the grid 212 is preferably changed through pull-down menus 214 displayed above the grid 212. Grids displaying such information are provided by TV Guide Online on its web site. In addition to displaying program information, the program grid 212 is preferably clickable such that a user can select a program to be recorded by clicking upon the depicted program. An Update Page button 216 preferably allows the user's selection(s) (programming instructions 118) on the Clickable Programming Page 210 to be updated on the host system 102. A Transmit button 218, performs the same function as the Update Page button 216 and, in addition, causes the host system 102 to transmit programming data 108 to the video recording system 120.

On a setup page (not illustrated) of the web site 104 the user 110 can preferably set preferences such as:

1. the user's locality and the type of broadcast video signals the user receives on his video recording system (e.g., user lives in city X and receives broadcast signals through cable company Y);

2. an identification number or code for the users video recording system 120 that allows the host system 102 to identify and transmit programming data 108 to the video recording system 120; and

3. the brand, model, and/or configuration of the user's video recording system 120. Alternatively, these preferences can be set when the user's account with the host system 102 is activated. The account may be activated either online, or possibly over the phone by a customer service representative.

FIG. 2C illustrates a Program Schedule Page 220 that preferably includes a Manually Add Programs section 222, a Recording Schedule section 224, a Recorded Programs section 226, and a Digital Recording Capacity section 228. The Manually Add Programs section 222 of the Page 220 preferably allows the user to add programs by date, time, channel, and perhaps title. The Recording Schedule section 224 preferably displays current programming instructions 118 that have been received by the host system 102. The Recording Schedule section 224 preferably has a column that may be checked to cancel outstanding programming instructions. The Recorded Programs section 226 preferably shows programs that have already been recorded by the video recording system 120. The Recorded Programs section 226 preferably has a column that may be checked to allow recorded programs to be deleted from the storage medium of the video recording system 120. The Digital Recording Capacity section 228 preferably displays the used, reserved, available, and total space on the video recording device's storage medium. The reserved space preferably corresponds to the space required by the programs displayed in the Recording Schedule section 224. In addition, the Program Schedule Page 220 preferably includes an Update Page button 230 that allows the user's entries in the various sections of the Program Schedule Page 220 as displayed by the web browser 112 to be updated on the host system 102. The Program Schedule Page 220 preferably also includes a Transmit button 232, which has a function similar to the Transmit button 218 on the Programming Page 212.

In one embodiment, the communication link 130 supports transmission of data from the video recording system 120 to the host system 102. In this case, the video recording system 120 can transmit state information 122 to the host system for display on the web site 104. The transmitted state information 122 may include recorded, scheduled, and deleted programs as well as recording capacities. Accordingly, the user 110 can record and delete recorded content directly through the video recording system 120, and have the state information 122 reflected on the web site 104.

In an alternative embodiment, the communication link 130 need not support transmission of data from the video recording system 120 to the host system 102. In this case, the host system 102 can generate the data in the Recorded Programs section 226 and the Digital Recording Capacity section 228 using predictive or simulation techniques, which will be apparent to one skilled in the art. The user 110 can supply to the host system 102 information regarding the total capacity of his video recording system 120. The host system 102 preferably maintains a history of recorded, scheduled, and deleted programs. Based upon the history, the host system 102 can calculate used, reserved, and available capacity. In another embodiment, the state information 122 is not displayed on the web site 104.

### II. Host System

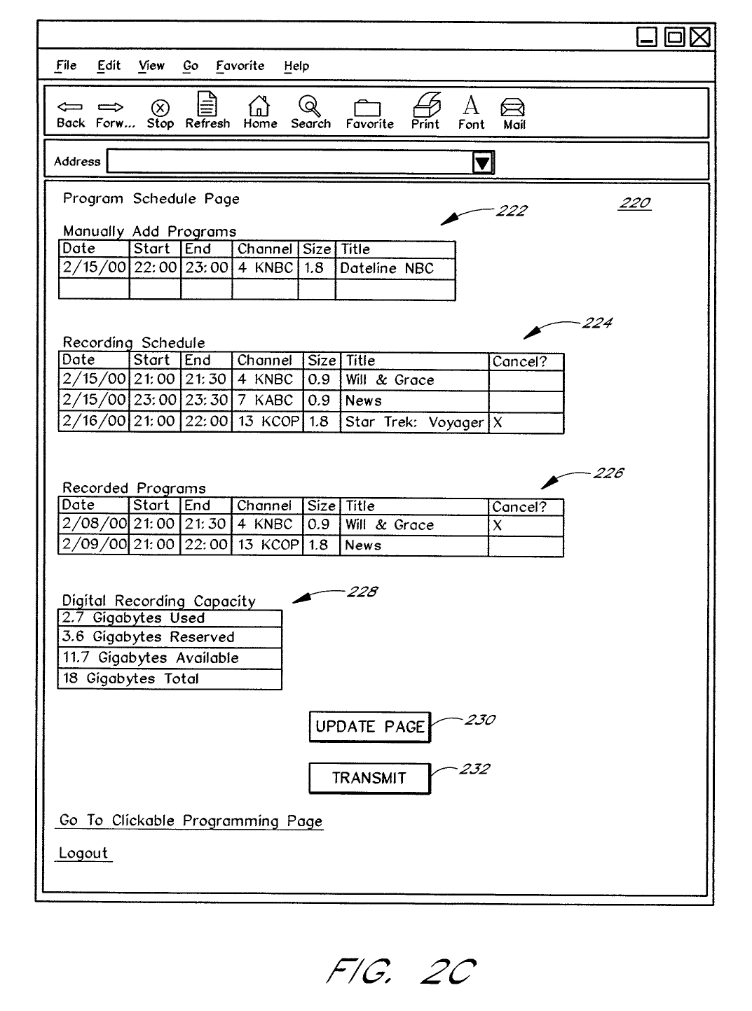

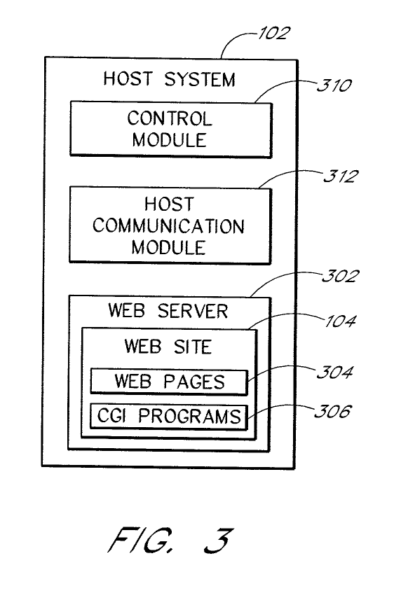

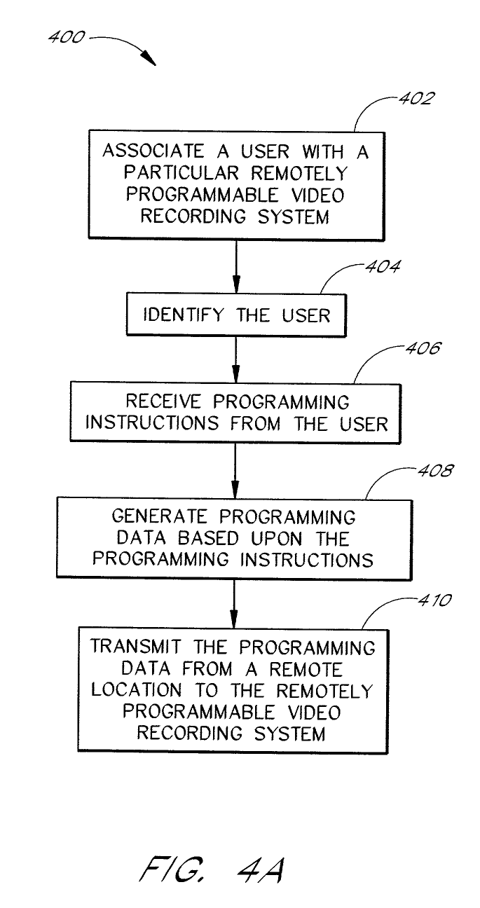

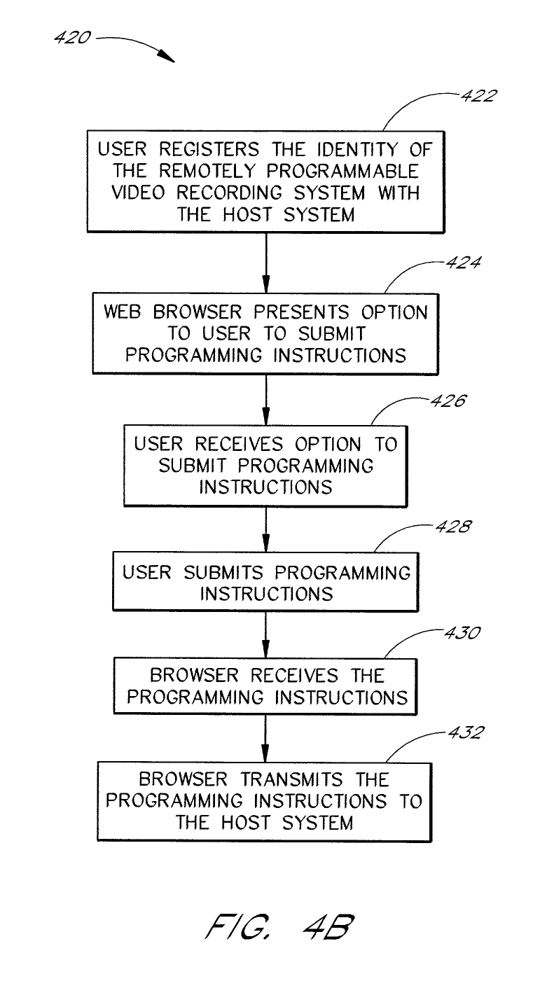

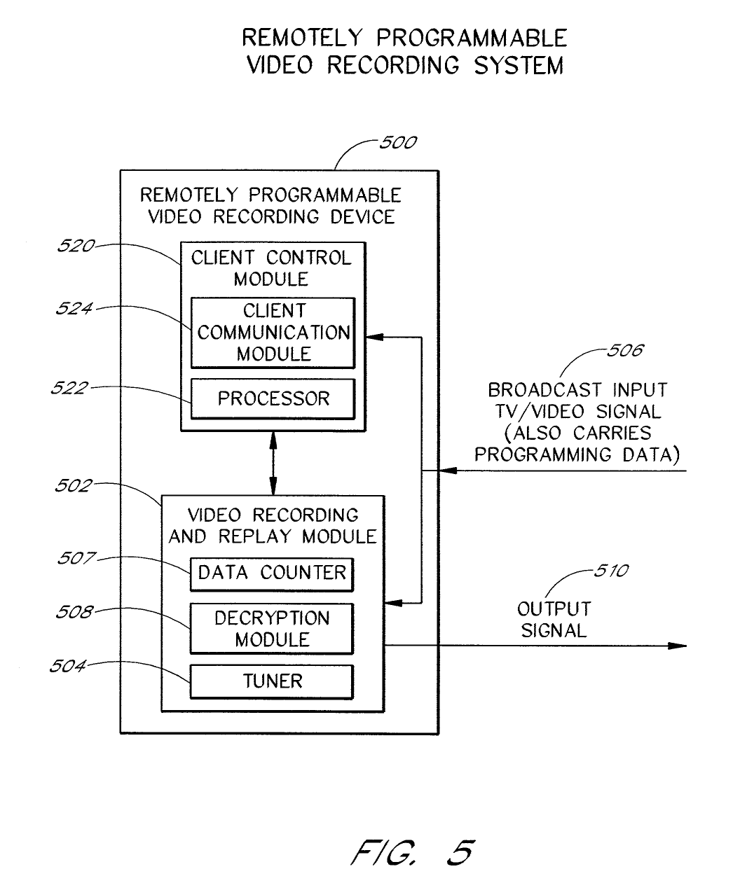

FIG. 3 illustrates a functional block diagram of one embodiment of the host system 102. The host system 102 preferably includes a control module 310, a server 302, and a host communication module 312. The host system 102 may be implemented as a single computer or several computers connected through a network.

The server 302 is preferably a web server that hosts the web site 104. The web site 104 preferably includes a number of web pages 304 (e.g., FIGS. 2A-C) as well as a number of common gateway interface (CGI) programs 306. The CGI programs 306 are configured to handle information submitted by the user 110 through the web browser 112 in response to the web pages 304. The CGI programs 306 preferably include a first program configured to receive information submitted through the Login Page 200 and to respond with the Clickable Programming Page 210. A second program is preferably configured to receive programming instructions 118 submitted by the user 110 in response to the Clickable Programming Page 210. A third program may service the Program Schedule Page 220. The CGI programs 306 preferably communicate the programming instructions 118 to the control module 310.

The control module 310 preferably controls the web server 302 as well as the host communication module 312. The control module 310 preferably creates programming data 108 based upon the programming instructions 118. The programming data 108 may also be based upon the brand, model, and/or configuration of the user's video recording system 120. The programming data 108 are configured to represent the programming instructions 118 and any other data necessary for programming the video recording system 120 in a format suitable for transmission over the particular communication link 130 being used.

The control module 310 preferably communicates the programming data 108 to the host communication module 312 for transmission to the video recording system 120. In one embodiment, the communication link 130 is implemented as a broadcast system in which all of the video recording systems receive all of the programming data 108 for all of the video recording systems. In this case, the host communication module 312 preferably prefixes the programming data 108 for each video recording system 120 with an identifier for that particular system. Each video recording system identifies programming data 108 intended for it by examining the prefixed identifier. The programming data 108 can be also encrypted to ensure privacy during transmission. In another embodiment, a computer network is used as the communication link 130. In this case, the control module 310 may also provide addressing data that may be required to direct the programming data 108 to the user's specific video recording system 120.

In one embodiment, VCR-Plus or similar technology is integrated into the video recording system 120. In this case, the programming data 108 are preferably VCR-Plus codes. When a video recording system 120 receives programming data 108 including a VCR-Plus code, the system 120 records the program identified by the code.

FIG. 4A illustrates a process 400 that is preferably performed by the host system to remotely program a video recording system 120. At a step 402, a user is associated with a particular remotely programmable video recording system 120. Step 402 may be performed by an account representative, such as when the user 110 sets up an account with a programming service. Alternatively, the step 402 may be performed during an on-line registration process through the web site 104. The user preferably supplies video recording system identification information that allows the host system 102 to transmit programming data 108 to the user's video recording system 120. Depending upon the technology used to implement the communication link 130, the identification information can be: a telephone number, in the case a telephone system is used; a media access control (MAC) address or an Internet Protocol (IP) address, in the case a computer network is used; an identifying prefix, in the case an open-air, cable, or satellite television signal is used; or a pager phone number, in the case a pager infrastructure is used. Various embodiments of the communication link 130 will be discussed in greater detail in Section IV below. Once the user 110 has signed up for the service and provided the required information at the step 402, the user 110 can program his remotely programmable video recording system 120.

At a step 404, the host system 102 identifies and preferably authenticates the user 110 in order to associate the user 110 with an account and a particular video recording system 120. In the embodiment illustrated in FIG. 2A, the identification of the user 110 is preferably performed through the Login Page 200. At the Login Page 200, the user supplies a User ID 202 and a password 204 for authentication.

The step 404 can alternatively be accomplished through the use of web browser cookies. In this configuration, the host system 102 deposits an identifying cookie on the user's web browser 112 preferably during the on-line registration process. The identifying cookie allows subsequent identification of the user 110. When the user requests a web page from the web server 302, the user's web browser 112 submits the cookie to the web server 302 allowing the web server 302 to identify the user 110 in accordance with step 404.

At a step 406, the web server 302 preferably receives programming instructions 118 from the user 110. In the embodiment illustrated in FIG. 2B, the user 110 submits the programming instructions 118 by choosing one or more programs to record through the Clickable Programming Page 210 or the Program Schedule Page 220. In one embodiment, the user 110 is first authenticated at the step 404 before programming instructions are received at the step 406. In alternative embodiments, the order of the steps 404 and 406 can be reversed, or the steps 404 and 406 can be performed simultaneously such as in conjunction with the use of identifying web browser cookies.

At a step 408, the control module 310 preferably creates programming data 108, based at least upon the programming instructions 118. In one embodiment, the control module encodes the programming instructions 118 for transmission over the communication link 130. In the case that a broadcast medium (e.g., broadcast television infrastructure) is used as the communication link 130, the programming instructions are preferably prefixed by a video recording system ID code. Alternatively, if a computer network is used as the communication link 130, the programming data 108 may be placed into addressed packets for transmission. The programming data 108 are also preferably encoded for the user's particular video recording system 120, possibly based upon brand, model, and/or configuration. In one embodiment, all remotely programmable video recording systems 120 can be configured to receive programming data in a common format. The programming data 108 may also be encrypted to ensure privacy.

At a step 410, the host communication module 312 preferably transmits the programming data 108 from a remote location to the video recording system 120 over the communication link 130. In one embodiment, one host system 102 is configured to service a large population, such as the continental United States or even the complete globe. The host system 102 is preferably operated from within one or more commercial buildings in the same general location. The majority or all of the video recording systems 120 are preferably located in users'homes. Therefore, the host system 102 will be remotely located with respect to most if not all video recording systems 120.

FIG. 4B illustrates a preferred process 420 performed by the user 110 and the web browser to remotely program the video recording system 120. At a step 422 the user 110 registers the remotely programmable video recording system 120 with the host system 102. The step 422 is preferably performed during a registration or account setup procedure in conjunction with the step 402 (FIG. 4A). At a step 424, the web browser 112 presents to the user 110 an opportunity to submit programming instructions 118 for programming the video recording system 120, preferably by displaying, for example, a programming web page, a link, a banner ad, or a clickable icon. At a step 426, the user receives the option presented in the step 424, and at a step 428, the user submits programming instructions 118, preferably by clicking on a depicted option. At a step 430, the web browser 112 receives the programming instructions 118, preferably by detecting the user's selection of a depicted option. At a step 432, the web browser transmits the programming instructions 118 to the host system 102, preferably by transmitting an http request encoded with the programming instructions 118.

### III. Remotely Programmable Video Recording System

FIG. 5 illustrates one embodiment of the remotely programmable video recording system 120 that is a remotely programmable video recording device 500. The device 500 preferably includes a video recording and replay module 502, and a client control module 520.

The recording and replay module 502 preferably includes a storage device for storing recorded content. The storage device can be, for example, a hard disk drive or a videocassette tape mechanism. In one embodiment, the recording and replay module 502 is a digital video recorder. The digital video recorder preferably uses a disk drive as a storage medium. Applicable technology is provided by TiVo Inc. of Sunnyvale, Calif. and ReplayTV, Inc. of Mountain View, Calif. The recording and replay module 502 may also be implemented as an analog video recorder using technology similar to that used in present VCRs.

The recording and replay module 502 preferably includes a tuner 504 capable of receiving and decoding a broadcast signal. The tuner enables the module 502 to receive and record an input broadcast signal 506, such as, for example, a signal broadcast over open-air television (e.g., from a transmission tower), cable television, or satellite television. The tuner is preferably capable of receiving and decoding a broadcast signal. The recording and replay module 502 preferably also includes a decryption module 508 that can be used to decrypt encrypted broadcast content. The recording and replay module 502 produces an output signal 510 upon playback or replay of recorded video content.

The client control module 520 preferably controls the video recording and replay module 502 through a processor 522, which may be a microprocessor or microcontroller. The client control module 520 preferably also serves as an interface to allow direct manual use of the video recording and replay module 502 possibly through a hand held remote control and possibly on-screen menus. The client control module 520 preferably includes a client communication module 524, which receives transmissions from the host system 102. The processor 522 preferably processes received programming data 108 and controls the recording and replay module 502 in accordance with the received data 108. In the case that the programming data 108 is transmitted over the same broadcast medium as the content to be recorded, the client communication module 524 is preferably also connected to receive the input broadcast signal 506. In one embodiment, the client control module 520 is enabled with VCR-Plus technology. The programming data 108 in this case can simply be formatted as VCR-Plus codes.

In the case that the communication link 130 supports transmission of data from the video recording device 500 to the host system 102, the processor 522 can be configured to transmit state information 122 to the host system 102 through the client communication module 524. In the case that the communication link 130 does not permit transmission of data to the host system 102, the recording capacity of the device 500 may eventually be used up. Once the device reaches capacity, the processor 522 can be configured to automatically delete content using any number of schemes, such as least recently viewed or recorded.

The client control module 520 is preferably also configured to receive secure communications from the host system 102. The processor 522 is preferably configured to execute decryption code that allows encrypted communications from the host system 102 to be decrypted using a decryption key or code. A corresponding encryption key or code can be supplied to the host system 102 by either the user 110 or the manufacturer of the video recording device 500. Accordingly, programming data 108 can be transmitted in a secure, encrypted form.

A secure communication channel also allows the host system 102 to transmit decryption keys for encrypted video content to the video recording device 500. As will be described in Section V below, the broadcast of encrypted content in conjunction with the supply of decryption keys to video recording devices 500 through the communication link 130 enables a pay per view type system with video on demand like capabilities. In conjunction with the pay per view configuration of the present invention, the video recording and replay module preferably also includes a data counter 507, which counts the amount of data from a proprietary program that has been replayed or presented. The data counter 507 is used to measure usage of proprietary content for billing purposes as will be discussed in Section V below.

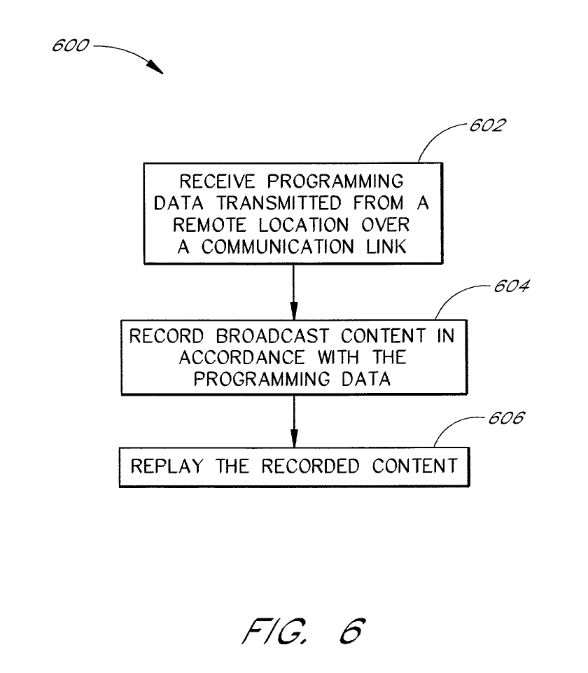

FIG. 6 illustrates a process 600 that is preferably performed by the remotely programmable video recording device 500. At a step 602, the video recording device 500 receives programming data 108 from the remotely located host system 102 over a communication link 130. The receipt in the step 602 by the video recording device 500 corresponds to the transmission in the step 410 (FIG. 4) by the host system 102. At a step 604, the video recording device 500 records broadcast content in accordance with the programming data 108, which may be one or more VCR-Plus codes. At a step 606, the video recording device 500 replays the recorded content, preferably as a result of direct user commands. The direct user commands are preferably received from a hand held remote control operated by the user 110 in the presence of the video recording device 500.

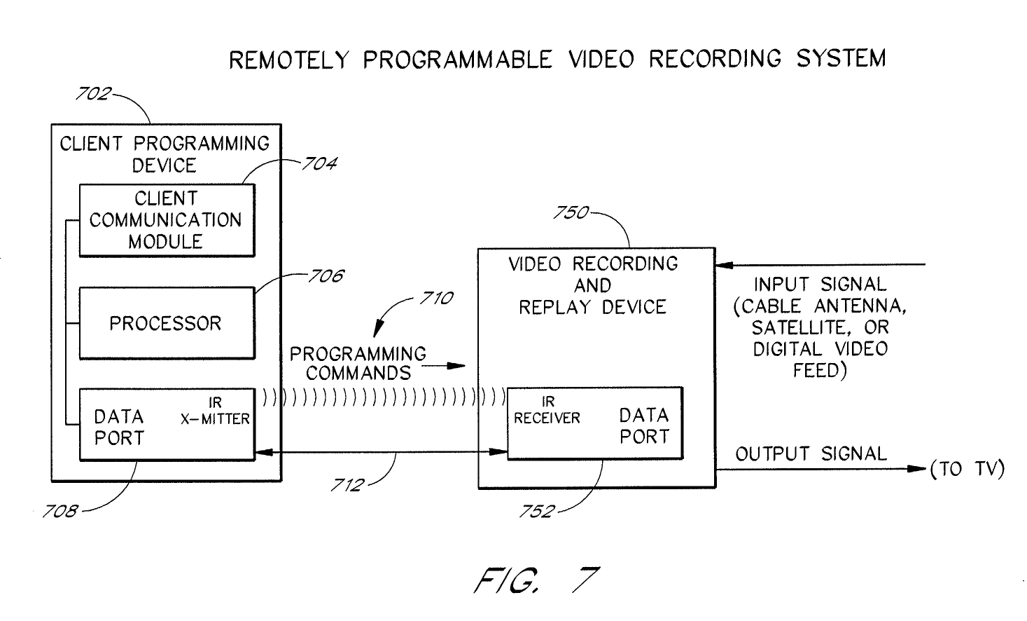

FIG. 7 illustrates an alternative embodiment of the remotely programmable video recording system 120. The alternative embodiment includes a client programming device 702 and a programmable video recording and replay device 750. The recording and replay device 750 may be a conventional VCR or a digital video recorder (personal video recorder) such as a TiVo or a ReplayTV device. The client programming device 702 is preferably a small, inexpensive device that can placed adjacent to the recording and replay device 750 to adapt the present invention to conventional VCRs and personal video recorders.

The client programming device 702 preferably communicates with the recording and replay device 750 through a data port 708. The data port 708 is preferably a module that supports bi-directional communication with the recording and replay device 750 through a bus or cable 712, for example. The bus or cable 712 connects the data port 708 of the client programming device 702 to a corresponding data port 752 of the recording and replay device 750. Through this bi-directional connection, the client programming device 702 can transmit programming commands to and receive status data from the recording and replay device 750.

The recording and replay device 750 may also include a data counter 507 and a decryption module 508, similar to the recording and replay module 502 (FIG. 5). In accordance with the pay per view type system described in Section V below, the client programming device 702 preferably communicates with the data counter 507 and decryption module 508 through the bi-directional connection.

As in many existing recording and replay devices 750, such as VCRs and digital video recorders, the data port 752 can be an infrared (IR) receiver. In this case, the data port 708 of the client programming device 702 can be an IR transmitter or can be connected to an IR transmitter that transmits commands in the form of IR pulses to the recording and replay device 750. Existing recording and replay devices 750 may not have a data counter 507 or a decryption module 508 and therefore a bi-directional connection need not be used. Alternatively, the data ports 708 and 752 may include both IR transmitters and receivers to support bi-directional communication if necessary.

The client programming device 702 includes a client communication module 704 and a processor 706 in addition to the data port 708. The client communication module 704 may be similar or identical to the client communication module 524 of the embodiment 500 illustrated in FIG. 5. The processor 706, which may be a microprocessor or microcontroller, preferably processes received programming data 108 to produce appropriate programming commands 710 that will be interpreted by the video recording and replay device 750 in accordance with the user's programming instructions 118.

The client programming device 702 can be configured, either directly by the user 110 or through the host system 102, with brand and model code information for the recording and replay device 750 similar to available “universal” remote controls. In this manner, the programming device 702 is configured to transmit the appropriate commands to the recording and replay device 750. Alternatively, the host system 102 can be configured to adapt the programming data 108 to take into account the brand and model of the recording and replay device 750. In this configuration, the client programming module 702 transmits data to the recording and replay device 750 based only upon the received programming data 108 and need not be configured for a particular model of recording and replay device 750.

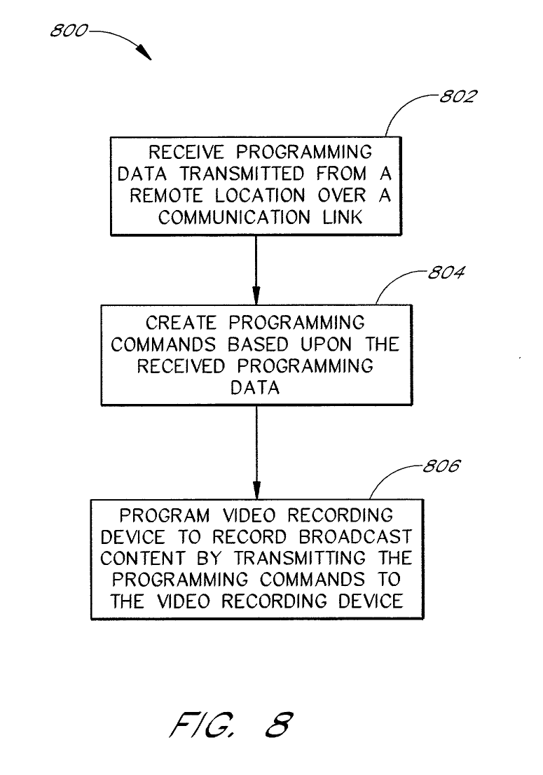

FIG. 8 illustrates a process 800 that is preferably performed by the client programming device 702. At a step 802, the client programming device 702 receives programming data 108 from the remotely located host system 102 over a communication link 130. The receipt in the step 802 by the client programming device 702 corresponds to the transmission in the step 410 (FIG. 4) by the host system 102.

At a step 804, the processor 706 preferably creates programming commands 710 based at least upon the received programming data 108 and preferably based upon the brand and model of the recording and replay device 750. In the case the recording and replay device 750 is capable of processing VCR-Plus codes, the processor 706 can simply format the VCR-Plus code for the particular model of recording and replay device 750. Alternatively, the host system 102 may be configured to create the programming data 108 based upon the brand and model of the video recording device 750. In this case the processor 706 may not have to create the programming commands but instead only relay the programming commands 710 to the data port 708 for transmission to the recording device 750. At a step 806, the client programming device 702 programs the video recording device 750 to record broadcast content by transmitting the programming commands 710 to the video recording device 750, preferably through the data port 708.

### IV. Communication Link

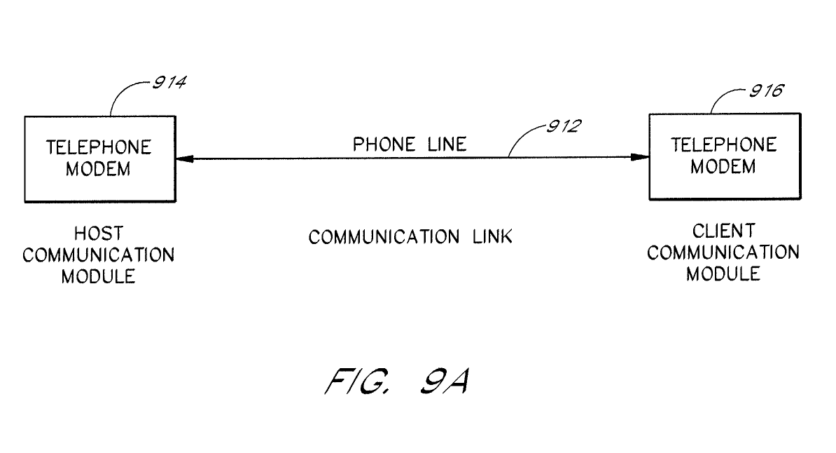

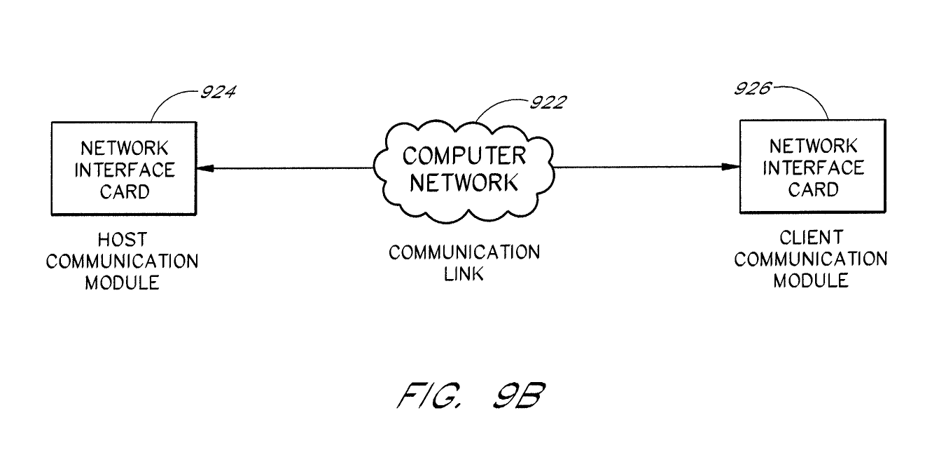

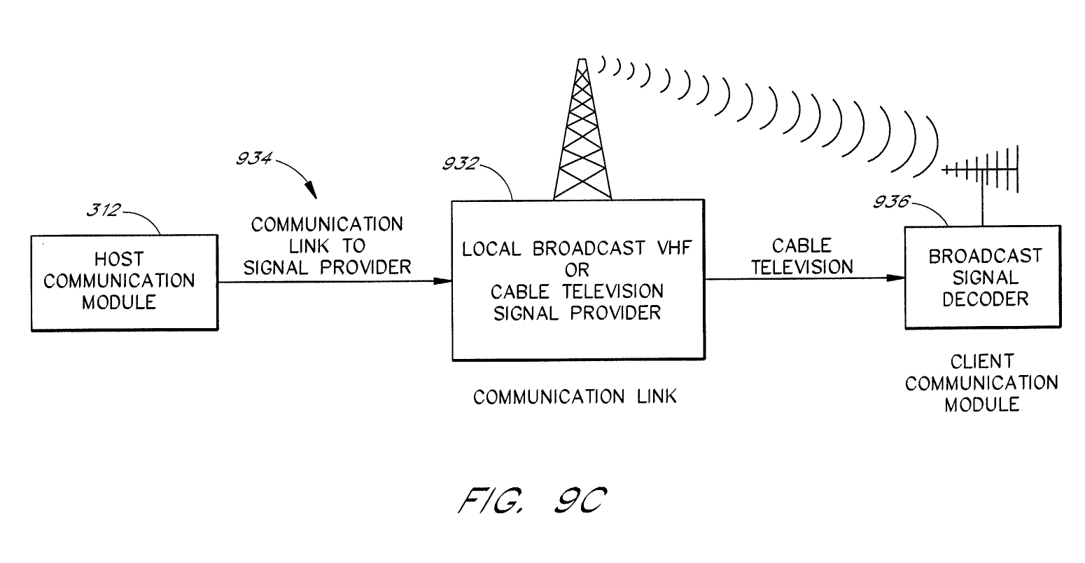

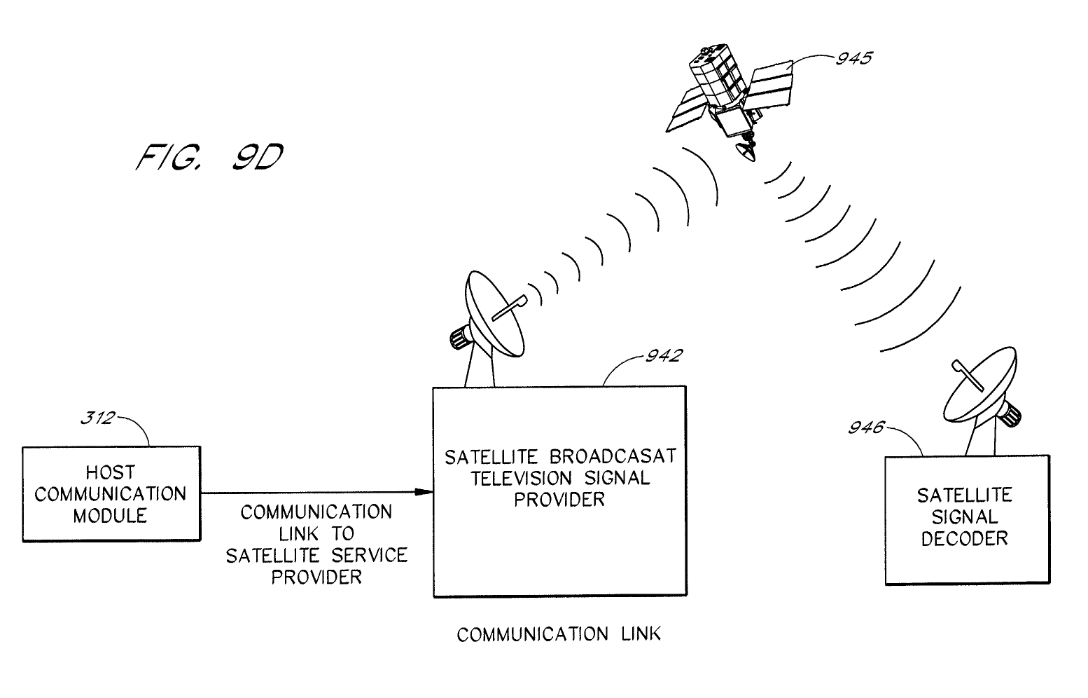

FIGS. 9A-E illustrate five embodiments of the host communication module 312, the client communication module 524 or 704, and the communication link 130. FIGS. 9A-B illustrate point to point connections that allow bi-directional communication between the host system 102 and the video recording system 120. FIGS. 9C-E illustrate broadcast transmission configurations in which information is transmitted only from the host system 102 to the video recording system 120. As will be understood by one skilled in the art, various features of the described embodiments may be combined to incorporate their respective advantages into a single embodiment.

FIG. 9A illustrates a basic embodiment in which the host communication module and the client communication module are both telephone modems 914, 916 connected through a telephone system or line 912. In one configuration, the video recording system 120 periodically calls the host system 102 (e.g. late at night) to check for and download programming data and to provide state information 122 to the host system. This configuration can be supplemented with a broadcast-type communication link (FIGS. 9C-E) in order to provide near instantaneous remote programming capabilities. In one embodiment, the host system 102 can be configured to use the telephone system 912 to call the video recording system 120 whenever the user 110 clicks on a “Transmit” button on a programming web page. Alternatively, the host system 102 can be configured to call the video recording system 120 just in time to transmit programming data 108 for a next scheduled recording event. These configurations provide instantaneous programming but may be inconvenient in that either an extra phone line is required or there may be contention for the use of a shared phone line.

In one embodiment, the recording system 120 (or the client programming device 702) can be configured with functionality available in some presently available fax machines so that two devices (e.g. client programming device and answering machine) can share a single telephone line. An answering machine message instructs the caller to press a number on the telephone keypad if the caller is sending a fax. The fax machine, upon detecting the resulting keypad tone, then takes over the call and receives a transmitted fax. In order to support near-instantaneous remote programming of a recording system 120, the recording system can be configured with similar technology to share a phone line with an answering machine and/or a fax. The host system can be configured to call the recording system and send an appropriate tone indicating that the call is specifically for the recording system. The recording system detects the tone, takes over the call, and communicates with the host system. Alternatively, the recording system can terminate the call upon receiving the tone from the host system and then call the host system back. In this configuration, the initial call from the host system can be used as a signal that synchronization is required (e.g., programming data is ready to be transmitted).

FIG. 9B illustrates an embodiment in which the communication link 130 is a computer network 922. The host communication module and the client communication module can be network interface cards 924, 926 or other communication devices that allow communication over the computer network 922. The network interface cards 924, 926 are preferably continuously connected through the computer network 922. The computer network may be a wide area network, such as the Internet, or it may be a local or home network.

In one embodiment, the host system 102 can be located in the user's home in conjunction with a remotely programmable video recording system 500. In this configuration, the communication modules 312, 524, and 704 can be home computer networking devices or wireless communication devices using technologies such as Bluetooth.

In FIG. 9C the host communication module 312 is configured to transmit programming data 108 to a local open-air (VHF/UHF) or cable television signal provider 932 preferably via a communication link 934. The communication link 934 may be implemented using any applicable technology such as a computer network. The provider 932 preferably retransmits the programming data 108 in conjunction with standard broadcast open-air television signals to the client communication module, which is preferably a broadcast signal decoder 936. The programming data 108 can be tagged with an identifier identifying the user's remotely programmable video recording system 120 so that other recording systems disregard the transmitted data 108. The programming data 108 can also be encrypted for decryption by the user's system 120 to ensure confidentiality. International Application WO 96/13932 to Ng discloses applicable technology wherein an identification of a television program in CDTL format is combined with a recorder identifier and transmitted in a vertical blanking interval of a broadcast signal. A recorder receives the CDTL data and identifier through the broadcast signal, and upon recognizing a matching identifier, stores the CDTL data to enable subsequent automatic recording of the identified program.

In FIG. 9D the host communication module 312 is configured to transmit programming data 108 to a satellite broadcast television signal provider 942. The provider 942 retransmits the programming data 108 in conjunction with satellite television signals via a satellite 945 to a satellite signal decoder 946. As will be understood by one skilled in the art, the features of the embodiment illustrated in 9C are also particularly applicable to the embodiment illustrated in FIG. 9D.

In FIG. 9E, the host communication module 312 is configured to transmit programming data 108 as page data to a paging service provider 952 by calling a phone number. The paging service provider 952 transmits the programming data 108 as a page through a paging infrastructure 954, which may include a satellite 955. In this embodiment, the client communication module is a pager unit 956 modified to output received page data in electronic form. In one configuration, each remotely programmable video recording system's pager unit 956 has its own pager phone number. In this configuration, the host communication module 312 can transmit a VCR-Plus code as the page data. Alternatively, the page data can be null and the video recording system can interpret a page as a signal to use the embodiment illustrated in FIG. 9A to call the host system to download the programming data 108. In another configuration, all of the pager units serviced by the host system 102 can be configured to be identical and receive and process all of the page data. For example, all pager units effectively may have the same pager phone number. In this configuration, the host system can transmit a particular recording system's identification number as the page data. When the recording system receives its own identification number as a page, it calls the host system using the embodiment of FIG. 9A.

### V. Distribution of Proprietary Content

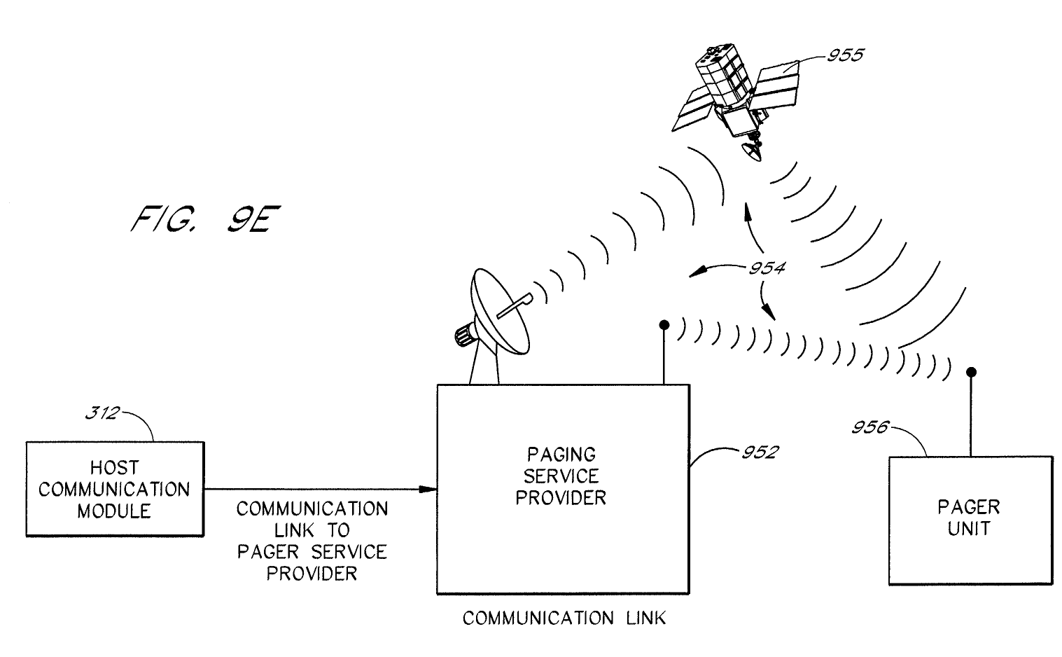

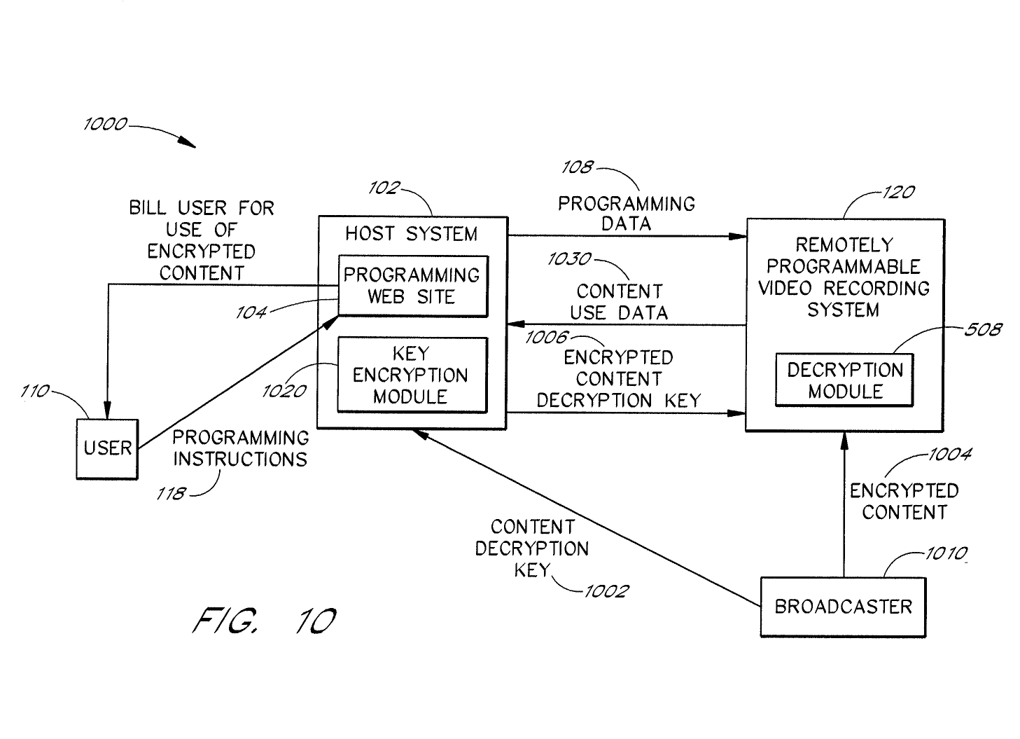

FIG. 10 illustrates one embodiment of a system 1000 for distributing proprietary or paid content. FIG. 11 illustrates a corresponding method 1100 in accordance with which proprietary content can be distributed. Preferably, popular programs, movies, and other proprietary video content units are encrypted and broadcast in digitally encrypted form on satellite, cable, or open-air broadcast channels. The host system 102 provides a decryption key 1002 to a video recording system 120 so that the recording system 120 can decrypt and present the content. The host system 102 preferably provides the key 1002 by encrypting the key such that it can be decrypted by the recording system 120 and transmitting the encrypted key 1006 in conjunction with programming data 108 to the recording system 120. FIGS. 10 and 11 will now be described concurrently in additional detail.

At a step 1102 of the method 1100, a proprietary content unit is digitally encrypted to create encrypted content unit 1004 that can be decrypted with a content decryption key 1002. The encrypted content 1004 is scheduled for broadcast by a broadcaster 1010 over a transmission infrastructure such as open-air, cable, or satellite television. The content unit can be encrypted by the broadcaster 1010, the owner of the content, or another party.

At a step 1104 the host system 102 obtains the content decryption key 1002 preferably from the broadcaster, the owner of the content unit, or the entity that encrypted the content unit. The transfer of the content decryption key 1002 from the broadcaster to the host system 102 is preferably performed using any secure communication or delivery method. The host system 102 preferably associates the content decryption key 1002 with the encrypted content unit 1004 so that the content decryption key can be supplied when a user chooses to record the content unit.

At a step 1106, the user 110 selects an encrypted content unit 1004 for recording in accordance with the present invention. In one embodiment, the host system 102 may bill the user for the content when the programming instructions 118 are received from the user. Alternatively, the host system 102 may defer billing until content use data 1030, which is described below, has been collected.

At a step 1108, the host system 102 encrypts the content decryption key 1002 to create an encrypted content decryption key 1006, which can be decrypted by the user's remotely programmable video recording system 120. By encrypting the content decryption key 1002, the host system is able to prevent the key 1002 from being intercepted and used by unauthorized parties. The host system may use a key encryption module 1020 to perform this encryption. Each video recording system 120 can be equipped with asymmetric key (e.g., public-private key) decryption technology that allows data to be encrypted by other devices only for decryption by the particular recording system. In this manner an encrypted content decryption key 1006 can be transmitted securely to a single video recording system 120.

At a step 1110, the host system 102 transmits the encrypted content decryption key 1106 to the user's video recording system 120 preferably in conjunction with programming data 108 for the requested proprietary program.

At a step 1112, the video recording system 120 receives the encrypted content decryption key 1006 and the programming data 108.

At a step 1114, the video recording system 120 decrypts the encrypted content decryption key 1006 in order to obtain the content decryption key 1002. The decryption module 508 of the recording system 120 can be configured to decrypt the encrypted key 1006.

At a step 1116, the video recording system 120 automatically records the encrypted video content 1004 when it is broadcast by the broadcaster 1004.

At a step 1118, the video recording system 120 decrypts the recorded encrypted content 1004 using the content decryption key. The decryption module 508 of the recording system 120 can be configured to decrypt the encrypted content 1004 using the content decryption key 1002. In one embodiment, the decryption module 508 can decrypt the content 1004 as the content is received such that the decrypted content is then stored by the video recording and replay module 502. Alternatively, the content 1004 can be stored in encrypted form for subsequent decryption during playback.

At a step 1120, the user preferably uses a hand held remote control to operate the video recording system 120 to present the decrypted video content.

At a step 1122 the video recording system preferably accumulates content use data 1030 during replay of the decrypted program. Content use data 1030 is information relating to the user's use of the content and is preferably representative of the amount the content has been used.

At a step 1124 the video recording system transmits the content use data 1030 to the host system 102. The host system 102 can then bill the user for the use of the program/content.

In one embodiment, the video recording system 120 stores content in a digital format. In accordance with this embodiment, content use data 1030 can be collected by tracking the amount of digital content data of a particular content unit that has been read or used. In this embodiment, content use is measured through a simple tracking of the amount of digital content data that is transferred or read. If certain data is read twice, it can be counted twice. A quantity of digital content data serves as an excellent measure of the amount of use the content unit has received. In accordance with this embodiment, the video recording system 120 preferably comprises a data counter 507 (FIG. 5) that counts the amount of data from a content unit that have been replayed or presented. The data counter 507 can be configured to just track the amount of content data read or used. Consequently, slow motion display, fast motion display, and multiple replay of a content unit or segment in determining how much a content unit has been used are automatically taken into account in determining the amount of use a content unit receives. For example, if a content unit occupies 2 Gigabytes of space and the user has displayed 2 Gigabytes of data, the user is charged for 1 viewing of the content unit. If the user has read 3 Gigabytes of digital content data from a content unit, it is likely that the user reviewed or replayed at least portions of the content unit, and the user is charged for 1.5 viewings. Technology applicable to the implementation of the data counter 507 is used in most networked computers and computer networking equipment to track network traffic and data rates.

In an alternative embodiment, the video recording system 120 does not or cannot transmit data to the host system 102. In this embodiment, the user can be charged for the purchase or use of the proprietary content unit upon submitting the programming instructions 118 at the step 1106. In this case the video recording system 120 need not collect any content use data 1030.

### VI. Program-Identifying Links and Banner Advertisements

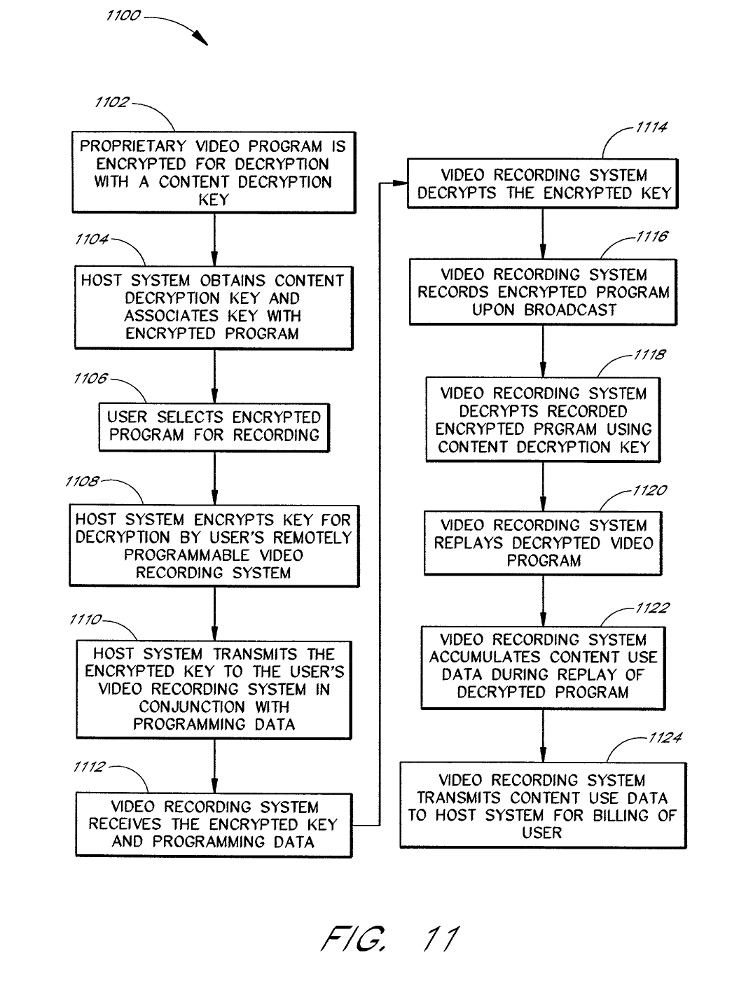

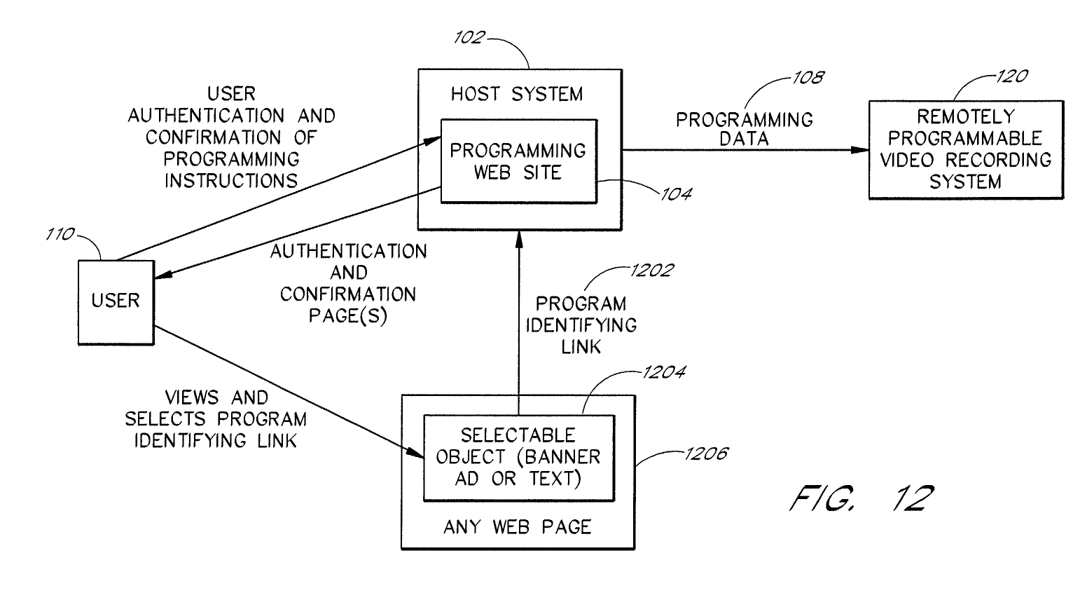

FIG. 12 illustrates one embodiment of the invention in which a program-identifying hypertext link 1202, preferably linking to the programming web site 104, can be located anywhere on the World Wide Web. The program-identifying link 1202 can be associated with a selectable object 1204 on any web page 1206. The selectable object 1204 can be any selectable object, such as an image or text, that represents a program to be recorded. The link 1202 is preferably a link to a URL hosted by the host system 102 and is preferably coded to generically identify the program to be recorded.

As illustrated in FIG. 12, by clicking on or selecting the selectable object 1204, the user follows the program-identifying link 1202. The program-identifying link 1202 supplies a generic identification of a program to the host system 102. In accordance with the step 404 of the method 400, the host system 102 identifies the user 110. The host system 102 can identify the user 110 through a Login Page 200 (FIG. 2A) that may be returned in response to the link 1202 or through the use of a web browser cookie that may have been previously deposited by the host system 102. Once the host system 102 identifies the user 110, the host system 102 associates the generically identified program with a particular channel, date, time, and length combination (CDTL) during which the program is to be broadcast to the user's video recording system 120. The host system 102 then returns a web page that preferably displays the programming details and requests confirmation of the programming instructions 118. The host system 102 receives the confirmation at the step 406 and transmits the proper programming data 108 to the user's video recording system 120.

In one embodiment, the web server 302 (FIG. 3) hosts the selectable object 1204. In the process of requesting the selectable object 1204 from the web server 302, the web browser 112 supplies an identifying cookie to the web server 302. In this manner, the web server 302 can identify the user 110 before the user views the selectable object 1204. The web server 302 then responds with the selectable object 1204 that presents to the user an option to record a particular program that the host system 102 has already confirmed is scheduled to be broadcast to the user's video recording system 120. In one configuration, the selectable object 1204 leads to a web page (not illustrated) on the web site 104 that preferably confirms the user's decision to record the program. In one embodiment, the user's single action of clicking on a selectable object 1204 can be sufficient to cause the host system 102 to remotely program the user's video recording system 120.

Clickable icons 1204 and the program-identifying links 1202 can be implemented using banner ad technology such as is provided by the well-known banner advertisement company DoubleClick, Inc. In accordance with the present invention however, the destination links of banner advertisements can be configured to cause a user's video recording device to be programmed.

As will be understood by one skilled in the art, the features of this Section can be combined with the features of Section V (Distribution of Proprietary Content) above in order to advertise the availability of proprietary content for distribution.

In one embodiment, a user can be presented with a banner advertisement that advertises, instead of a program or movie, a broadcast commercial or video advertisement that the user may be interested in watching. The banner advertisement can be configured in accordance with the techniques disclosed in this Section to cause the user's remotely programmable video recording device to record the advertised commercial. The user can then watch the commercial at a convenient time rather than when the commercial happens to be broadcast. DoubleClick, Inc. provides technology that allows banner ads to be targeted to users browsing the web based upon the user's previous selections. This technology, in addition to other ad-targeting technology can be used to target users with banner advertisements that advertise commercials that may be of particular interest. Since commercials can be easily recorded by users' recording devices, commercials can be broadcast less frequently, such as once per day. In accordance with this embodiment, commercials can be more effectivly targeted to viewers, viewers can avoid watching commercials that are not of interest, and advertisers can avoid paying to repeatedly broadcast the same commercial.

### VII. Program Request Integration

Local cable television service providers generally have at least a hundred and sometimes several hundred channels upon which to broadcast content. Oftentimes, it may be the case that many of these channels are not watched by even a few people within a whole service area for extended periods of time, such as late at night. Viewers will frequently find scrolling text ads, low-viewership programs, and paid commercial advertising on these channels late at night. The result is that a tremendous amount of bandwidth is wasted during late night and off-peak hours. In accordance with one embodiment of the invention, this bandwidth is used to distribute content that is recorded and then watched during more convenient viewing hours.

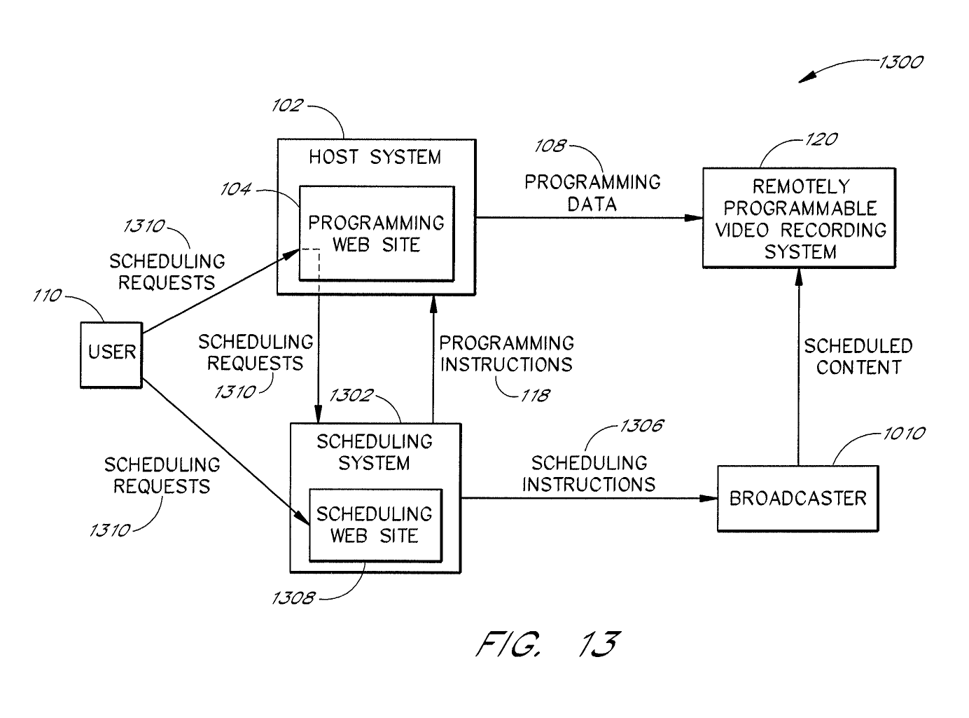

FIG. 13 illustrates one embodiment 1300 in accordance with which users can request that certain content be broadcast through a scheduling system 1302. When content is scheduled to be broadcast in response to a request, the host system 102 automatically sends programming data to the user's remotely programmable video recording system 120 to cause the system to record the requested content.

In one embodiment, the programming web site 104 provides a search utility that allows a user 110 to search for a particular content unit of interest. It may be the case that the content unit is not scheduled to be broadcast at all or that the content unit is scheduled to be broadcast too far in the future. In such cases, the programming web site 104 can present the user 110 the option of making a scheduling request 1310 that the content unit of interest be scheduled for broadcast at some time in the near future. The host system 102 receives the scheduling request 1310 from the user 110 and then preferably forwards the scheduling request to the scheduling system 1302.

The scheduling system 1302 can be configured to schedule the broadcast of content units for broadcast using any scheduling algorithm or method. If there is sufficient unused bandwidth available in the broadcasting system, the scheduling system 1302 may schedule the requested content unit for immediate broadcast. On the other hand, if bandwidth is limited, the scheduling system may schedule the requested content unit to be broadcast some time in the future. By broadcasting a content unit in the future, the content unit becomes a scheduled program that other users can also select to be recorded. As a content unit is scheduled further into the near future, the number of users that will likely record the content will likely increase up to a certain point. In accordance with one embodiment, higher demand content units can be scheduled sooner while lower demand content units can be scheduled further into the future so that an maximum number of users record each content unit when it is broadcast. As a result broadcast bandwidth is more efficiently utilized.

Once the scheduling system 1302 schedules a content unit for broadcast, the scheduling system 1302 sends programming instructions 118 back to the host system 102. The scheduling system 1302 can formulate the programming instructions 118 based upon the broadcast time that the scheduling system 1302 has decided upon. The host system 102 receives the programming instructions 118 and then formulates programming data 108 that it then transmits to the video recording system 120 in accordance with the aforementioned embodiments. The programming web site 104 can also update the program grid 212 (FIG. 2) and/or a list of scheduled content to reflect the scheduling information received in the programming instructions 118 from the scheduling system. In the case that the content unit is scheduled for broadcast at some time in the future, other users can also record the same content unit through the programming web site 104.

The scheduling system 1302 also provides scheduling instructions 1306 to a broadcaster 1010 that broadcasts to the user's video recording system 120. The broadcaster 1010 then broadcasts the requested content in accordance with the scheduling instructions 1306 so that the requesting user's and others' video recording systems 120 can receive and record the broadcast content unit.

As an alternative to having the host system 102 forward scheduling requests 1310 to the scheduling system 1302, the scheduling system 1302 can support its own web site 1308. Users can go directly to the scheduling web site to request the scheduling of proprietary content or content that is generally not broadcast on a regular basis. When a scheduling request is made through the scheduling web site 1308, the scheduling system 1302 can determine if a requested content unit has already been scheduled, and if so, it may rely upon the already scheduled broadcast. If the requested content has not been scheduled, then the scheduling system 1302 can proceed to schedule the broadcast of the requested content. In either case, the scheduling system 1302 sends the appropriate programming instructions for the requesting user's video recording system to the host system 102.

In one embodiment, the functionality and features of the scheduling system 1302 and the host system 102 are combined in a single system with a single web site. The features of the scheduling system 1302 and of this Section in general can also be combined with the features of Section V (Distribution of Proprietary Content) above to provide a pseudo-on-demand proprietary content distribution system.

### VIII. Broadcast Scheduling

In one embodiment, the host system 102 maintains statistics relating to the number of users that have scheduled each broadcast show for recording. These statistics can be used for various purposes, such as determining what content to broadcast and when to broadcast it.

A broadcaster can use the collected statistics to determine the frequency at which to rebroadcast repeating content or serial programs. Suppose, for example, that a broadcaster broadcasts movies on a certain channel. A movie can be scheduled for rebroadcast at a rate (e.g., hours of movie per day) that is proportional to the rate (e.g. number of requests, per hour of movie, per day) at which users record the movie. Movies that are requested less frequently can be broadcast less frequently. By scheduling content with a rate that is proportional to the rate at which the content is recorded, the average number of users recording content from the channel can be maximized.

The statistical information obtained from the host system can also be used to determine when to schedule programs. Programs that are recorded more frequently can be broadcast before or during peak watching hours in order to reduce or minimize the amount of time an average user will have to wait to watch a program.

### IX. Recording Other Types of Content

In one embodiment, the present invention can be configured to record other types or forms of content that can be broadcast in digital form, such as audio content, data, or software. In order to capture these varied types of content, a computer can be configured with a digital broadcast signal receiver to receive broadcast content. Any type of content can then be digitally encoded and broadcast through a digital broadcast signal, such as available digital television bandwidth. iBlast, Inc. (www.iblast.com) provides technology that enables computers to receive various types of digitally encoded broadcast content. In accordance with the technology of the present invention, computers can be further configured to receive programming data 108 through which they can be programmed to record or store broadcast content. In addition, any type of broadcast can be encrypted and decryption keys can be encrypted and transmitted to individual receiving computers to provide a general proprietary content distribution system in accordance with the techniques presented in Section V.

In one embodiment, the recording system 120 can be configured to receive broadcast FM radio or to receive digital radio stations that are provided by many cable and satellite television service providers.

### X. Web Server Enabled Video Recording System

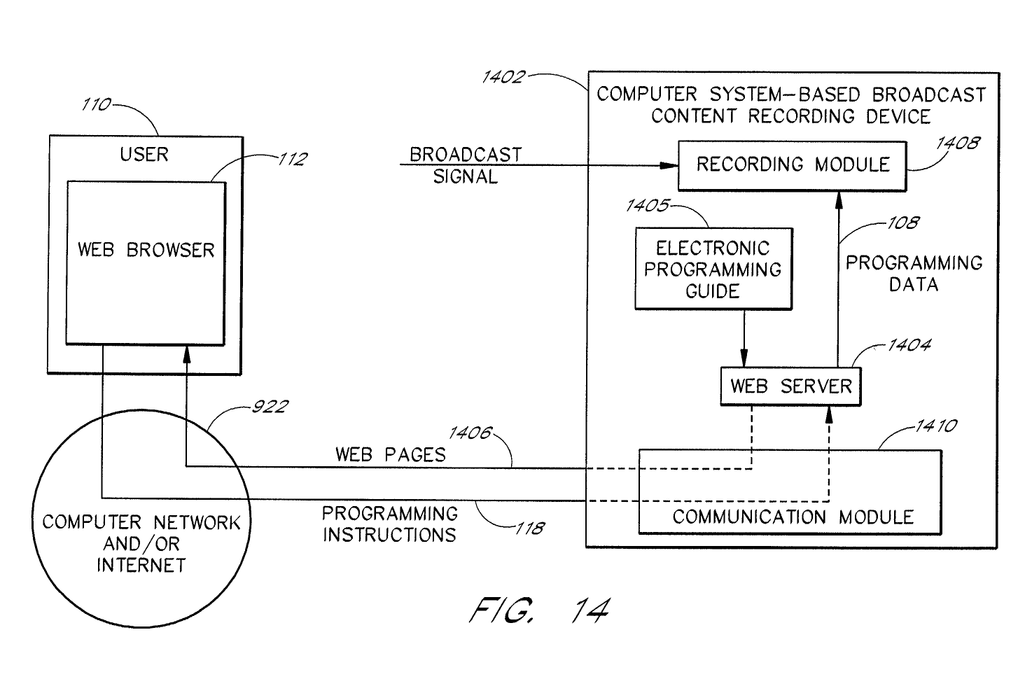

FIG. 14 illustrates one embodiment of the invention in which a content recording device 1402 is supplemented with a web server 1404 to provide a point of presence on the World Wide Web. The web server 1404 can be configured to serve a small number of web pages 1406 that enable a user 110 to program the recording device 1402 through a web browser 112. The web pages 1406 can include a Login Page 200 (FIG. 2A), a Clickable Programming Page 210 (FIG. 2B), a Program Schedule Page 220 (FIG. 2C), and a Setup Page such as are described in Section I.

The content recording device 1402 is preferably based upon a computer system platform so that little or no additional hardware is necessary to support the web server 1404. Alternatively, the device 1402 can be a computer system supplemented with a digital broadcast signal receiver (e.g., in accordance with iBlast, Inc. technology). Presently available digital video recorders are generally based upon stripped-down computer systems and little or no hardware would have to be added in order to run a web server 1404. The TiVo personal video recorder, for example, is essentially a stripped down computer system that runs the Linux operating system and has an MPEG-2 video codec. Alternatively, a separate computer system can be used to support the web server 1404.

In accordance with this embodiment, much of the functionality of the host system 102 can be incorporated into the web server 1404, eliminating the need for a separate host system 102. The web server 1404 can also include any ancillary programs (e.g., CGI scripts) necessary to generate web pages, process web page requests, and/or receive and process received programming instructions 118. The web server 1404 and a programmable recording module 1408 are preferably connected in communication in a single device.

The web server preferably creates programming data 108 based at least on programming instructions 118 received from the user 110 and provides the programming data 108 to the recording module 1408. In one embodiment, the programming data 108 can be the unmodified programming instructions 118. The programming data 108 identifies the content to be recorded. The recording module 1408 receives the programming data 108 and records the identified broadcast content. The recording module 1408 preferably also includes replay functionality that supports the replay of recorded content. The recording module 1408 can be configured to include any of the features of the recording and replay module 502 (FIG. 5).

A communication module 1410 provides access to the web server 1404 from the Internet or a computer network 922. The communication module 1410 preferably provides a constant-on connection so that the web server 1404 can be accessed at any time. The communication module 1410 can be a network interface card that supports TCP/IP and can be connected directly to the Internet. Alternatively, the communication module 1410 can be any home networking (e.g., wireless or home LAN) through which a connection to the Internet can be provided. The communication module 1410 is preferably configured with a dedicated IP address so that the web-server can be easily accessed at a known address. Alternatively, the communication module 1410 and the computer system 1402 can be configured to use Dynamic Host Configuration Protocol to obtain a dynamically assigned an IP address from a server. In this case, a third party host system, such as the server assigning the IP address, could be used to redirect the user to the dynamically assigned IP address. The third party host system is preferably accessible at a dedicated IP address.

The web server 1404 preferably accesses an electronic programming guide 1405 to create the programming web pages for the user 110. The electronic programming guide 1405 can be downloaded through the communication module 1410 or through a modem by calling a server from which the data can be made available.

### XI. Alternative and Additional Embodiments

In one embodiment, the video recording system 120 is configured to include a removable media drive, preferably with write and read capability, such as a DVD or CD read/write drive. The removable media drive is preferably included in addition to the recording and replay module 502 or the primary recording media used by the video recording system 120. In this configuration, any type of recorded content can be transferred onto removable media for use elsewhere. In conjunction with the proprietary content distribution system described in Section V, the data counter 507 can log the amount or number of transfers of proprietary content onto removable media and the user can be charged according to the number of copies made.

In one embodiment, digitally encoded content can be broadcast in faster than real time for simultaneous or subsequent playback at normal speed. In order to broadcast content in faster than real time, additional bandwidth can be used to provide a higher speed broadcast link. Alternatively, compression technology (e.g., MPEG-4 or DivX) can be used to compress content such that it can be broadcast in faster than real time using a standard bandwidth channel. High-demand programs can be broadcast repeatedly in faster than real-time on a single channel. For example, an hour-long show can be broadcast in 15 minutes, repeating every 15 minutes. The video recording system 120 can record the program at faster-than-real-time-rate and can simultaneously or later play back the program at normal speed. Using a combination of wasted bandwidth, high speed broadcast, and recording for delayed viewing, large amounts of content can be cost effectively distributed to viewers. Such content may include proprietary content that is subject to viewing charges in accordance with the techniques presented in Section V.

In one embodiment, a set top box with recording and web browsing functionality can be used in conjunction with the present invention. The set-top box can be configured to receive remotely transmitted programming data and/or decryption keys. In one configuration, the set-top box can be configured to receive content decryption keys in conjunction with the remotely transmitted programming data. In another configuration, the set-top box need not be programmed remotely and can be programmed directly by the user. In this configuration, the set-top box can use received programming schedules to schedule the recording of encrypted content. The set-top box can also request and receive decryption keys from a host system. The host system can in turn bill the requesting user for content for which decryption keys are provided.

In one embodiment, the host system can be configured to receive e-mail from users, wherein programming instructions are included in the e-mail. A user can compose an e-mail message on any e-mail capable device, such as, for example, a computer, a digital phone with e-mail capability, or a personal digital assistant. The e-mail preferably contains an identifier of the user and an identifier of the content unit to be recorded. The user can be identified by a return address of the e-mail or by another identifier, such as a user ID included in the e-mail. The content unit can be identified using, for example, a VCR-Plus (Video Plus) code or any other coding scheme. The host system can be configured to receive and process the e-mail in accordance with known techniques in order to identify the user and the content unit to be recorded. The host system can then program the remotely programmable video recording to record the selected content in accordance with the present invention.

In one embodiment, a specially configured client program can be configured to run on a user computer 114 to allow a user 110 to send programming instructions 118 to the host system 102 without using web pages. The client program can provide a simple interface through which CDTL data is entered. The client program and a remotely programmable recording device 120 can alternatively be configured to communicate with one another through a computer network. In these configurations, the client program can provide a remote user interface to the remotely programmable recording device 120 without using a web browser or web pages.

In certain instances, such as when recording short content units (e.g., commercials) it is advantageous to configure the timing of a recording session to correspond precisely with the broadcast of a content unit. Gemstar International Group Limited provides technology whereby indication signals that signal the precise beginning and end of content units are broadcast in conjunction with the content units. The indication signals can be received by recording devices and used to precisely time the recording of content. These signals can account for the unplanned shifting of the time of broadcast content due to delays such as sporting events.

In one embodiment, the web pages 106 of the web site 104 can be coded using VoiceXML, the web browser 112 can be a voice web browser, and the user computer 114 on which the voice web browser executes can be a VoiceXML gateway. In accordance with known techniques, the VoiceXML, the voice web browser, and the VoiceXML gateway are configured so that a user can browse web pages by listening to speech synthesized VoiceXML pages and responding with voice commands that are interpreted with automated speech recognition technology. In this embodiment, the user can call a VoiceXML gateway on the telephone, listen to various options of content to be broadcast and provide programming instructions via voice commands. Additional information on VoiceXML is available from www.voicexml.org.

### XII. Conclusion

One skilled in the art will recognize that many of the functions of the various functional blocks and modules described can be performed by alternative functional blocks and modules. For example, in one embodiment, the web server 302 of the host system 102, instead of the control module 310, can be configured to create the programming data 108.

One skilled in the art will recognize that the various embodiments of the invention disclosed herein can be combined in a single embodiment. Furthermore, the functionality disclosed with respect to certain embodiments need not be included in all embodiments.

While certain embodiments have been described and shown in the accompanying drawings, it is to be understood that such embodiments are merely illustrative of and not restrictive on the broad invention. Further, it is to be understood that this invention is not limited to the specific construction and arrangements shown and described since various modifications or changes may occur to those of ordinary skill in the art without departing from the spirit and scope of the invention as claimed. It is intended that the scope of the invention be limited not by this detailed description but by the claims appended hereto. In the method claims, reference characters are used for convenience of description only, and do not indicate a particular order for performing the method.

What is claimed is:

1. A method of programming a remotely programmable content recording system to record broadcast content, the method comprising:
(a) receiving a programming instruction transmitted over a computer network by a user computer in response to a user's input to the user computer, wherein the programming instruction identifies broadcast content that has been selected by the user to be recorded by the remotely programmable content recording system; and
(b) using the received programming instruction to program the remotely programmable content recording system to record the identified content.

2. The method of claim 1, wherein the user's input is received through a web browser executing on the user computer.

3. The method of claim 2, wherein the user's input to the user computer comprises a selection of a user-selectable display element.

4. The method of claim 3, further comprising transmitting a web page to the user computer, wherein the web page is configured to cause the web browser to display the user-selectable display element.

5. The method of claim 2, further comprising transmitting a programming web page to the user computer in response to a request transmitted by the user computer, wherein the programming web page comprises code configured to cause the web browser to display to the user an identification of the broadcast content.

6. The method of claim 5, wherein the programming web page further comprises code that configures the web browser to receive the input from the user.

7. The method of claim 2, further comprising serving a state web page in response to a request transmitted by the user computer, wherein the state web page comprises code configured to cause the web browser to display state information descriptive of a state of the remotely programmable content recording system.

8. The method of claim 7, wherein the state information comprises an amount of storage capacity available on the recording system for recording new content.

9. The method of claim 1, wherein (b) is performed by the remotely programmable content recording system.

10. The method of claim 1, wherein the computer network is the Internet.

11. The method of claim 1, wherein the programming instruction identifies a broadcast television program.

12. The method of claim 1, wherein the programming instruction identifies a time period and a broadcast channel.

13. The method of claim 1, wherein the programming instruction comprises a VIDEO PLUS code.

14. The method of claim 1, wherein the broadcast content is broadcast television content.

15. The method of claim 1, wherein the broadcast content is audio content.

16. The method of claim 1, wherein the broadcast content is digital video content.

17. The method of claim 1, wherein the broadcast content is computer software.

18. The method of claim 1, wherein the remotely programmable content recording system comprises a programmable content recording device and a separate programming device configured to receive programming data, wherein the programming device is connected in at least one-way communication with the programmable content recording device.

19. The method of claim 1, wherein (b) comprises
in response to receiving the programming instruction, transmitting programming data to the remotely programmable content recording system, wherein the programming data are configured to cause the remotely programmable content recording system to record the selected content.

20. The method of claim 19, wherein the programming data identify the broadcast content.

21. The method of claim 19, wherein the programming data comprise the programming instruction.

22. The method of claim 21, wherein the broadcast content is broadcast in encrypted form.

23. The method of claim 22, further comprising
in response to receiving the programming instruction, transmitting a content decryption key to the remotely programmable content recording system, wherein the content decryption key can be used to decrypt the broadcast content.

24. The method of claim 23, wherein the content decryption key is encrypted in such a manner that the content decryption key can be decrypted by the remotely programmable content recording system.

25. The method of claim 23, wherein the content decryption key is encrypted in such a manner that the content decryption key cannot be decrypted by other remotely programmable content recording systems.

26. A hypertext link configured such that a traversal of the link causes a programming instruction to be transmitted over a computer network, wherein the programming instruction identifies a broadcast content unit, and wherein the programming instruction is configured to cause the identified broadcast content unit to be recorded by a remotely programmable broadcast content recording system.

27. A web page comprising:
an identification of a content unit scheduled to be broadcast; and
code that configures a web browser to transmit a programming instruction in response to input from a user, wherein the programming instruction is configured to cause a remotely programmable content recording system to record a broadcast of the content unit.

28. The web page of claim 27, wherein the content unit is identified in a clickable broadcast program grid.

29. The web page of claim 28, wherein the clickable broadcast program grid depicts broadcast programs based upon at least broadcast time and broadcast channel.
